(19) United States
(12) Patent Application Publication
(10) Pub. No.: US 2003/0104868 A1
(43) Pub. Date: Jun. 5, 2003

(54) Game server device, game management method, recording medium storing game management program and game device

(75) Inventors: Katsunori Okita, Kobe-shi (JP); Kazutaka Kubota, Akashi-shi (JP); Yuuki Harano, Kobe-shi (JP); Hiroyuki Wada, Kobe-shi (JP); Masakazu Shibamiya, Kobe-shi (JP); Takashi Makiishi, Kobe-shi (JP)

Correspondence Address: JORDAN AND HAMBURG LLP, 122 EAST 42ND STREET, SUITE 4000, NEW YORK, NY, 10168, US

(73) Assignee: Konami Corporation, Tokyo (JP)

(21) Appl. No.: 10/274,211

(22) Filed: Oct. 18, 2002

(30) Foreign Application Priority Data
Nov. 30, 2001 (JP) 2001-367596
Dec. 28, 2001 (JP) 2001-401845

(51) Int. Cl. A63F 13/00

(52) U.S. Cl. 463/42

(57) ABSTRACT

The present invention enables selection of appropriate opponent players for a player of a game. The CPU 361 of the controller of the center server device comprises a receiving unit 361a that receives a request for game participation from each player when a game begins on each respective client terminal device 1, a selection unit 361b that selects according to prescribed rules a number of players to play in a shared game space from among the players from whom game participation requests have been received by the receiving unit 361a, the number being no more than a prescribed maximum number and no less than a prescribed minimum number, and a first execution unit 161d that allows players selected by the selection unit 361b to play a game against one another in a shared game space.

### BACKGROUND OF THE INVENTION

1. Field of the Invention

The present invention pertains to a game server device that is connected to a plurality of terminal devices such that data communication can take place therebetween and manages a game played by a plurality of players using the terminal devices, and to an associated game management method and recording medium which stores a game management program, as well as to a game device that comprises game execution means that enables the execution of a competition-type game played via player operations and permits players to join a game under prescribed conditions, and to an associated game management method and a recording medium which stores a game management program.

2. Description of the Related Art

Various types of video game devices that enable games to be played among a plurality of players have been proposed or are presently in use. Furthermore, arcade games are known in which a plurality of such video game devices (terminal devices) of the same model are connected over a LAN or over a network such as the Internet (and servers), such that a plurality of players can play a game in a shared game space. These types of video game devices permit the playing of table games such as mah-jongg or ‘shogi’ (Japanese chess) or of competition-type games such as sports games or wrestling games.

Where the above table games or competition-type games are played, because a plurality of video game devices are connected over a LAN or over a network such as the Internet (and servers), an unspecified number of players can participate in the game. Where players who cannot see each other play against one another in this fashion, because no one knows the level of the opponent players' skill in the game, in comparison with a regular game that is played using a standalone video game device with the video game device as the opponent, the game can be given a higher degree of unpredictability, and can accordingly be made more interesting to a certain degree.

Furthermore, in these games, when a competition-type game ends, the next game is begun by once again recruiting an unspecified number of players. Moreover, in a regular game, as an incentive for players to continue to play the game, the players' game achievement for a game that has ended is commonly displayed on the screen of the monitor or other display apparatus for each player. The game achievement may comprise the number of ‘lives’ or number of points possessed by the player, which increases or decreases in response to the game achievement for each player. More specifically, in a shooting game, the game achievement may comprise a number of points earned corresponding to the number of enemy characters defeated, while in a mah-jongg game, the game achievement may comprise the number of chips possessed by the player in accordance with the game achievement.

### SUMMARY OF THE INVENTION

Table games such as mah-jongg and ‘shogi’ can vary widely in their degree of interest to players depending on the opponents. For example, in the case of a mah-jongg game, a player who enjoys the process of developing his hand prefers not to play against an opponent who determines to secure a quick win and often scores ‘pon’ (triplets), which considerably diminishes the player's enjoyment of the game. Similarly, for a highly skilled player, having to play an opponent possessing lesser skill can destroy the fun of playing, because the relative lack of quality of such an opponent leaves the player feeling unsatisfied with the game. In the conventional art, where a plurality of video game devices are connected over a network (and servers), opponents are selected in the order in which they access the system, or are selected randomly, and as a result, incompatible (or undesired) opponents are chosen, and the excitement of the game may be lost.

Furthermore, in the above game, even if by the end of the game a player has scored the maximum number of points available in the game, for example, normally only the player's name and points scored are recorded. As a result, even though the player's game achievement places him at an extremely high level, those results are not reflected in the next game in which the player participates.

A first object of the present invention is to provide a game server device, game management method and game management program that select opponents suitable for the player.

A second object of the present invention is to provide a game device, game management method and game management program that enable the player's game achievement to be reflected in the next game.

One form of the present invention to achieve the above objects relates to a game server device that is connected to a plurality of terminal devices in a data-communicable fashion and that manages a game played by a plurality of players using said terminal devices, said game server device comprising: receiving means that receives requests for participation in a game from players at the commencement of a game at each terminal device; selection means that selects from among the players whom game participation requests have been received from, in accordance with prescribed rules, a number of players who are to play in a shared game space, the number being no more than a prescribed maximum number and no less than a prescribed minimum number; and first execution means that allows the selected players to play a game against one another in a shared game space.

According to the above invention, requests for participation in a game are received from players by the receiving means at the commencement of a game at each terminal device, a number of players who are to play in a shared game space are selected by the selection means in accordance with prescribed rules from among the players whose game participation requests have been received, such number being equal to or less than a prescribed maximum and equal to or greater than a prescribed minimum, and a game is executed in a shared game space for the selected players by the first execution means. Therefore, where a rule exists that players having the same level of skill based on past performance are to be chosen as opponents, for example, opponents who are suitable for the player (players having the same skill-level) are selected. As a result, a highly skilled player does not feel the dissatisfaction of competing against an inferior opponent, and a game that maintains a certain level of excitement can be ensured.

These and other objects, features, and advantages of the present invention will become more apparent upon reading the following detailed description along with the accompanying drawings.

### BRIEF DESCRIPTION OF THE DRAWINGS

FIG. 1 is a schematic diagram of a game system in which the game server device pertaining to the present invention is applied;

FIG. 2 is a perspective view showing the external appearance of one embodiment of a client terminal device;

FIG. 3 is a hardware schematic diagram showing one embodiment of a client terminal device;

FIG. 4 is a function block diagram pertaining to the controller of the client terminal device;

FIG. 5 is a perspective view showing the external appearance of one embodiment of an arcade server device;

FIG. 6 is a hardware schematic diagram showing one embodiment of an arcade server device;

FIG. 7 is a hardware schematic diagram of one embodiment of the center server device 3 pertaining to the present invention;

FIG. 8 is an example of a function block diagram of the controller of the center server device;

FIG. 9 is an example of a flow chart showing the operations of the center server device;

FIG. 10 is an example of a detailed flow chart of the step ST5 (the opponent determination routine) shown in FIG. 9;

FIG. 11 is an example of a screen drawing of an idle screen;

FIG. 12 an example of an idle screen indicating the result of selection;

FIG. 13 is an example of a detailed flow chart of the routine of step ST67 (the standby status routine) shown in FIG. 10;

FIG. 14 is an example of a screen drawing of a game reservation screen which is a screen shown during a CPU game;

FIG. 15 is an example of a screen drawing of an opponent advent screen;

FIG. 16 is an example of a detailed flow chart of the routine of step ST57 (the player selection routine) shown in FIG. 10;

FIG. 17 is an example of a detailed flow chart of the routine of step ST7 (the game monitoring routine) shown in FIG. 9;

FIG. 18 is an example of a flow chart showing the operations of the client terminal device;

FIG. 19 is an example of a screen drawing of a mode selection screen for selecting a game mode;

FIG. 20 is an example of a screen drawing of a game screen showing the game status;

FIG. 21 is an example of a screen drawing of a play continuation selection screen;

FIG. 22 is an example of a screen drawing of a play continuation selection screen;

FIG. 23 is an example of a screen drawing of a play continuation selection screen;

FIG. 24 is an example of a flow chart showing the operations of the client terminal device;

FIG. 25 is an example of a screen drawing of a play continuation selection screen; and

FIG. 26 is an example of a screen drawing of a play continuation condition screen.

### DESCRIPTION OF THE PREFERRED EMBODIMENTS

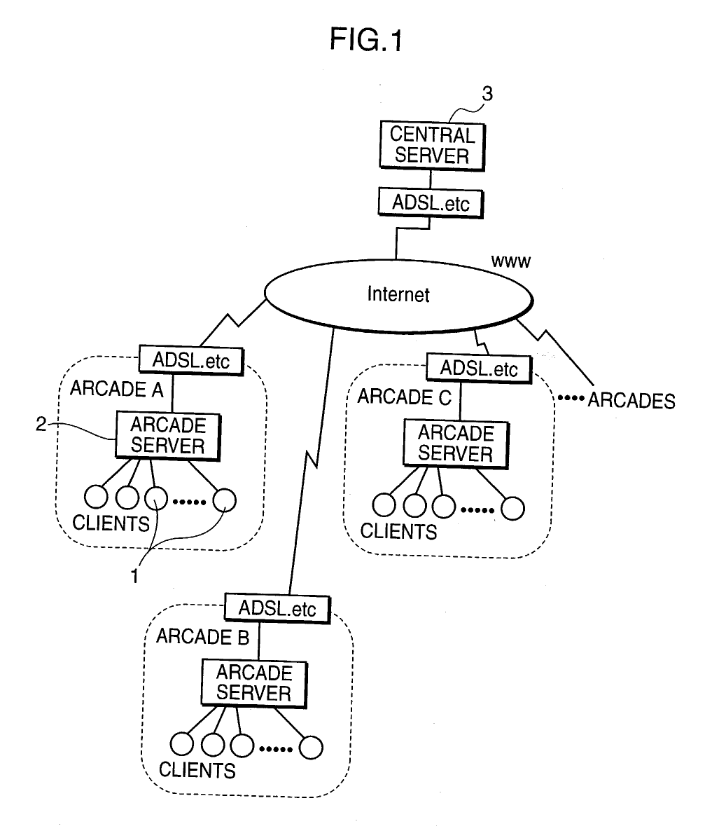

FIG. 1 is a schematic diagram of a game system in which the game server device pertaining to the present invention is applied. This game system comprises a plurality of client terminal devices 1 (corresponding to terminal devices and the game devices), each of which is associated with its own identification information, a plurality of arcade server devices 2 that are each data-communicably connected to the plurality (here eight) of client terminal devices 1, and a central server 3 (corresponding to a game server device) that is data-communicably connected to the plurality of arcade server devices 2 and manages multi-player games played by a plurality of players using the client terminal devices 1.

Games are played on the client terminal devices 1 via prescribed operations by players on a game screen displayed on a monitor. The identification information associated with each client terminal device 1 includes identification information pertaining to the arcade server device 2 to which the client terminal device 1 is connected (or identification information pertaining to the arcade in which the client terminal device is installed), as well as identification information pertaining to the client terminal device 1 within the arcade in which the client terminal device 1 is installed (referred to as ‘terminal number’). For example, where the identification information for the arcade A is ‘A’, and the identification information for the client terminal device 1 within the arcade A is ‘4’, the identification information for that client terminal device 1 is ‘A4’.

Each arcade server device 2 is connected to the plurality (here, eight) of client terminal devices 1 and to the center server device 3 in a data-communicable fashion, such that it communicates data between the client terminal devices 1 and the center server device 3.

The center server device 3 is connected to the plurality of arcade server devices 2 in a data-communicable fashion. It stores, as player information, player fingerprint characteristic data needed for fingerprint verification to be described below in association with the player's user ID, and also selects players to play a game in a shared game space (referred to as ‘opponents’) by transmitting and receiving data to and from each client terminal device 1 via the arcade server device 2.

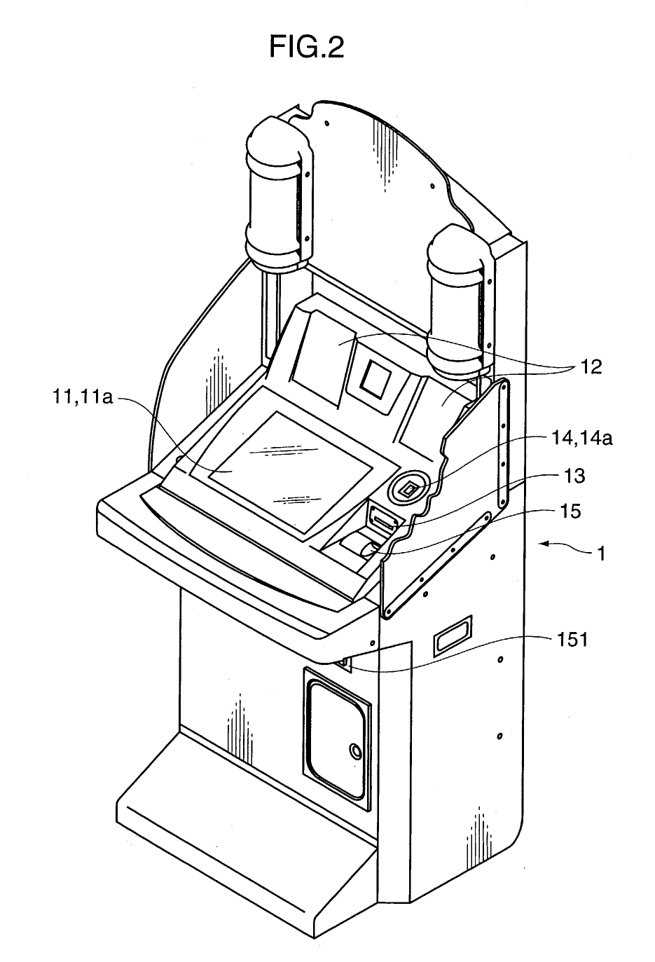

FIG. 2 is a perspective view showing external appearance of one embodiment of the client terminal device 1. In the description below, a commercial video game apparatus that incorporates a monitor is used as an example of the client terminal device 1 for purposes of explanation, but the present invention is not limited to this example, and may be applied in the same fashion to a home video game terminal device comprising a home video game machine connected to a household television, or to a personal computer or the like that functions as a video game terminal device via the execution of a video game program.

Moreover, in this embodiment, the game played using the client terminal device 1 pertaining to the present invention is a mah-jongg game, where the player who operates a client terminal device 1 plays at least either against players using other client terminal devices 1 or against virtual players implemented by the CPU of the player's own apparatus. When the player is competing against players using other client terminal devices 1, data is communicated among the client terminal devices 1 via network communication units 18 described below, the arcade server device 2 and the center server device 3. Furthermore, of the players playing the mah-jongg game in a shared game space, (i.e., at the same virtual table), at least one is a CPU player.

The client terminal device 1 includes a monitor 11 that displays the game screens, a touch panel 11a that determines which of the buttons was pressed, based on the addresses of the buttons that prompt selections or the like that are shown on the game screens of the monitor 11 and the location at which pressure was applied by the player, a speaker 12 that outputs sound, a card reader 13 that reads information such as a user ID stored in a personal card, a fingerprint verification unit 14 that extracts characteristic data needed for personal authentication based on fingerprint information captured by a CCD camera 14a described below, and a coin receiving unit 15 that receives coins inserted by the player. The characteristic data extracted by the fingerprint verification unit 14 is stored in a player information unit 362a (described below) of the center server device 3 via a network communication unit 18 described below, the arcade server device 2, etc.

The monitor 11 is a thin liquid crystal display, for example, that displays images. The speaker 12 outputs prescribed messages or BGMs. The fingerprint verification unit 14 includes a CCD camera 14a that captures images of the player's fingerprints. A different type of digital imaging device (such as a CMOS camera) may be used in place of the CCD camera 14a. The coin receiving unit 15 includes a coin ejection outlet 151 from which invalid inserted coins are ejected.

While not shown in the drawings, the personal card is a magnetic card or IC card that stores personal information such as a user ID, and the card reader 13 enables such information to be read from the personal card inserted therein.

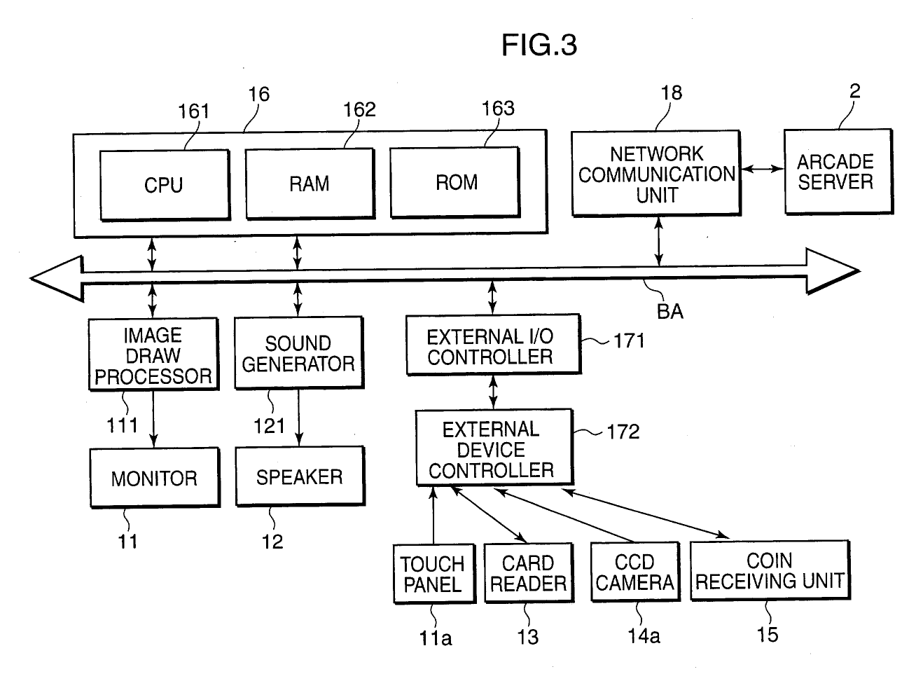

A controller 16 (see FIG. 3) constituted by a microcomputer or the like that inputs detection signals from the various components and outputs control signals to the various components is located at an appropriate location in the client terminal device 1.

FIG. 3 is a hardware schematic diagram showing one embodiment of the client terminal device 1. The controller 16 controls the overall operation of the client terminal device 1, and includes a central processing unit (CPU) 161, a RAM 162 that temporarily stores information that is being processed, and a ROM 163 in which prescribed image information as well as game programs and the like described below are stored beforehand.

An external I/O controller 171 is located between the controller 16 and the detection units including the card reader 13, the touch panel 11a, the CCD camera 14a and the coin receiving unit 15. It converts detection signals into digital signals for processing, as well as converts command information into control signals, outputs the digital signals or control signals to the controller 16 or to the various detection units, and conducts this signal processing and I/O processing using time division, for example. The external device controller 172 outputs control signals to the various detection units and inputs detection signals from the various detection units during their respective time division periods.

The image draw processor 111 displays necessary images on the monitor 11 in accordance with image display commands from the controller 16, and includes a video RAM. The sound generator 121 outputs to the speaker 12 prescribed messages or BGMs in accordance with commands from the controller 16.

The touch panel 11a is a rectangular thin layered body that is constituted by aligning pressure-sensitive elements made of a linear transparent material horizontally and vertically at a prescribed pitch, and covering the aligned pressure-sensitive elements by a transparent cover, and is affixed to the screen surface of the monitor 11. The touch panel 11a may be of a public-domain technology, and is constructed such that it can determine which of the buttons was pressed, based on the addresses of the buttons that prompt selections or the like that are shown on the screen of the monitor 11 and the location at which pressure was applied by the player.

Mah-jongg tile characters, background images, images for the various screens and the like are stored in the ROM 163. The mah-jongg tile characters and the like are constituted by an appropriate number of polygons such that they can be drawn in a three-dimensional fashion, and the image draw processor 111 performs, based on image draw commands from the CPU 161, processing for calculation to convert positions in a three-dimensional space into positions in a pseudo-three-dimensional space and light source calculation, as well as processing for the writing of the image data to be drawn to the video RAM based on these calculation results, i.e. processing for the writing (pasting) of texture data to the area of the video RAM specified using polygons, for example.

The relationship between the operation of the CPU 161 and the operation of the image draw processor 111 will now be described. The CPU 161 reads out from the ROM 163 images, sounds, control program data and game program data based on the operating system (OS) stored in the ROM 163, which may be either incorporated in the CPU 161 or an external apparatus removably mounted on the CPU 161. All or part of the read-out images, sounds, control program data and the like are saved in the RAM 162. Processing is then performed by the CPU 161 based on the control program and various data (image data such as polygons and texture for displayed objects and other character images, as well as sound data), as well as on detection signals from the detection units.

Among the various types of data stored in the ROM 163, data that can be stored on a detachable recording medium can be read using a driver such as a hard disk drive, an optical disk drive, a flexible disk drive, a silicon disk drive, a cassette reader or the like, and in this case, the recording medium may be, for example, a hard disk, optical disk, flexible disk, CD, DVD, semiconductor memory or the like.

The network communication unit 18 enables the transmission and receipt of various types of event information generated during the execution of the mah-jongg game to and from the center server device 3 via the arcade server device 2 and the network.

The personal authentication method implemented by the video game device 1 will now be described. Personal authentication confirms that the player who is recognized by the client terminal device 1 (or the center server device 3 that is connected via the network communication unit 18 and the network) is in fact the same player who is actually playing. Where a player wishes to play on the client terminal device 1 for the first time, the card reader 13 reads out user ID data from the personal card inserted therein, the CCD camera 14a of the fingerprint verification unit 14 captures an image of the player's fingerprint, and characteristic data necessary for personal authentication is extracted using the fingerprint information from the CCD camera 14a. The user ID data and characteristic data are then transmitted via the network communication unit 18 and the network to the arcade server 2 to which the client terminal device 1 is connected, and are then transmitted from the arcade server 2 over communication lines to the center server device 3, and are stored in a player information storage unit 362a described below. The player is thereby registered with the center server device 3.

Where a player already registered with the center server device 3 wishes to play on the client terminal device 1, the card reader 13 reads out user ID data from the personal card inserted therein, the CCD camera 14a of the fingerprint verification unit 14 captures an image of the player's fingerprint, and characteristic data necessary for personal authentication is extracted using the fingerprint information from the CCD camera 14a. The user ID data and characteristic data are then transmitted to the center server device 3 connected to the client terminal device 1 via the network communication unit 18, the network and the arcade server 2, and the center server device 3 determines whether or not the transmitted characteristic data is identical to the characteristic data corresponding to the user ID stored in the player information storage unit 362a described below. If the determination is positive, play is permitted for the player, while if the determination is negative, play is denied (for example, an error message is displayed on the monitor of the client terminal device 1 and the user is prompted to re-attempt fingerprint verification).

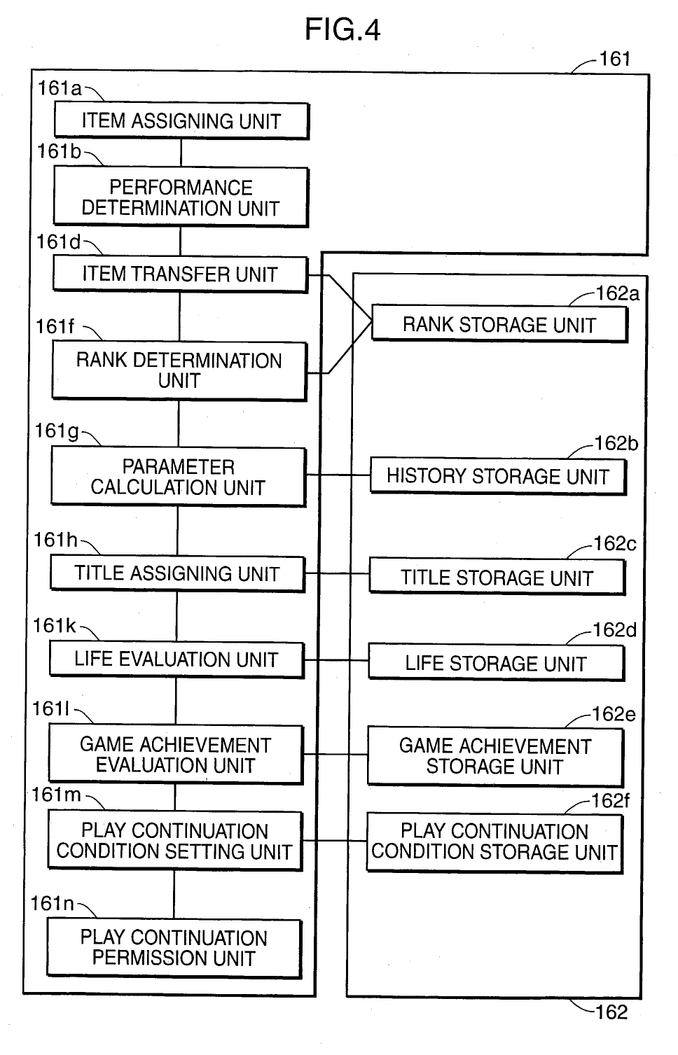

FIG. 4 is a function block diagram showing the controller 16 of the client terminal device 1. The CPU 161 of the controller 16 comprises item assigning unit 161a that virtually assigns a prescribed number of items to players who satisfy prescribed condition, a performance determination unit 161b that, when a game ends, determines the order in which the players finished in that game, an item transfer unit 161d that, based on the results of the determination by the performance determination unit 161b, transfers among players a prescribed number of items from among the items virtually possessed by the players, a rank determination unit 161f that determines a rank indicating the level of a player's skill at mah-jongg based on the number of items virtually possessed by the player, a parameter calculation unit 161g that calculates parameters indicating the characteristics of each player expressed during games based on the history data stored in a history storage unit 162b described below, a title assigning unit 161h that assigns a title applicable during games to each player based on the calculated parameters, a life evaluation unit that calculates and determines the amount of life that is the gauge for determining whether play continuation will be permitted, a game achievement evaluation unit 161l that determines game achievement at the end of a game by evaluating the player's operations during the game, a play continuation condition setting unit 161m that, based on a player's game achievement determined by the game achievement evaluation unit 161l, sets play continuation condition under which the player is allowed to continuously play the next game, and a continuous participation permission unit 161n that permits, in response to the receipt of a request for continuous participation in the next game at the end of a game, participation in the next game under the play continuation condition set by the play continuation condition setting unit 161m.

The RAM 162 of the controller 16 includes a rank storage unit 162a that associates a number of items and a rank with each player and stores them in memory, a history storage unit 162b that stores past game history data for each player, a title storage unit 162c that associates the title assigned by the title assigning unit 161h with each player and stores it in memory, a life storage unit 162d that stores life values calculated by the life evaluation unit 161k, a game achievement storage unit 162e that stores values for the points represented by chips possessed by the player evaluated by the game achievement evaluation unit 161l, and a play continuation condition storage unit 161f that stores the play continuation condition under which a player will participate in the next game on a continuous basis, while associating such condition with the possessed chip value (i.e., the game achievement value) for the player.

The item assigning unit 161a virtually assigns items (‘dragon chips’ in this embodiment) to players who satisfy prescribed condition, increases or reduces the number of points virtually possessed by the players, and associates with each player and stores in the rank storage unit 162a the number of items and points corresponding to each player. The method by which the number of points is increased or decreased and the condition for the assignment of items will now be described specifically. During the game, when a player wins, the number of points virtually possessed by the player is increased by a prescribed number, and when the player loses on ‘furikomi’, i.e., on his own discard, the number of virtually possessed points is reduced by a prescribed amount. For example, where the player wins, the number of points obtained for winning is increased by 20 points for every 1000 points possessed. Where the player loses on his own discard, the number of points possessed by the player is reduced by 10 points for every 1000 points in his score. Where the number of points is 1000 or higher, three items, i.e., dragon chips, are virtually assigned.

When the game having the number of deals selected by the table selection unit 161c has been completed, the performance determination unit 161b determines the order of the players' finish, with the first-place finisher being the player who virtually possesses, as chips, the largest number of points. However, the number of points possessed as chips by each player when the game begins (referred to as the ‘starting points’) is identical. For example, the starting points figure is 20,000 points.

After the order of finish of the players in the game is determined by the performance determination unit 161b, the item transfer unit 161d transfers among the players a prescribed number of items from among the items virtually possessed by the players, based on the results of the determination by the performance determination unit 161b and the number of deals selected by the table selection unit 161c. Specifically, two dragon chips are transferred from the fourth-place finisher to the first-place finisher, and one dragon chip is transferred from the third-place finisher to the second-place finisher. Furthermore, the item transfer unit 161d stores the number of dragon chips in a rank storage unit 162a described below on a continuously updated basis.

The rank determination unit 161f determines a rank indicating the level of the player's skill at mah-jongg based on the number of items virtually possessed by the player, stores the rank in the rank storage unit 162a described below while associating it with the player's name, and sends the name-associated rank to the center server device 3 via the network and the arcade server device 2. The method used to determine this rank will now be described in specific condition below.

A player is assigned a rank of Grade 10 when he plays the game for the first time. The rank becomes Grade 9 when the player's number of points is between 100 and 199, for example. As the player's point total rises (or falls) his rank is increased (or decreased) accordingly, such that where the player possesses between 900 and 999 points, he becomes a Grade 1 player, for example. Once the player reaches 1000 points, he becomes a 1^{st} degree master.

As described above, the item assigning unit 161a virtually assigns three items, i.e., dragon chips, to a player who attains 1000 points. Thereafter, the number of dragon chips virtually possessed by each player fluctuates depending on the transfers among the players of their dragon chips by the item transfer unit 161d based on the results of the determination by the performance determination unit 161b, and is stored on a continuously updated basis in the rank storage means 162a described below. For example, a player who has five or more but fewer than 10 dragon chips is deemed a 2^{nd} degree master. As the player's number of dragon chips rises (or falls), his rank is increased (or decreased) accordingly, and a player who possesses 46 or more dragon chips is deemed an 8^{th} degree master.

In other words, the rank determination unit 161f determines the appropriate rank with reference to level tables that associate a given number of points or items with a rank and are stored in table format, based on the number of points determined by the item assigning unit 161a and the number of items determined by the item assigning unit 161a and the item transfer unit 161d.

When a player is determined by the rank determination unit 161f to be at 1^{st} degree master rank, the parameter calculation unit 161g calculates parameters indicating the characteristics of the player's games based on the history data stored in the history storage unit 162b described below. These parameters include the ‘win ratio’, ‘furikomi ratio’, ‘average number of dora tiles held on win’ and ‘average number of exponentials held on win’.

(Win ratio)=(Cumulative number of deals won)/(Cumulative number of deals played)

(Furikomi ratio)=(Cumulative number of furikomi losses)/(Cumulative number of deals played)

(Average number of dora tiles held on win)=(Cumulative number of dora tiles held when winning a deal)/(Cumulative number of deals won)

(Average number of exponentials held on win)=(Cumulative number of exponentials when winning a deal)/(Cumulative number of deals won)

The cumulative number of deals won, cumulative number of furikomi losses, cumulative number of deals played, cumulative number of dora tiles held when winning a deal, cumulative number of exponentials when winning a deal and cumulative number of deals won, which are used in the formulae described above, are associated with each player and are stored in the history storage unit 162b described below.

When a player is determined by the rank determination unit 161f to be at 1^{st} degree master rank, a title applicable during games is virtually assigned to the player and associated with the player's name by the title assigning unit 161h based on the parameters calculated by the parameter calculation unit 161g, and the name-associated title information is stored in the title storage unit 162c. In addition, the title information is sent to the center server device 3 via the network communication unit 18, the network and the arcade server device 2.

The method by which a title is assigned will now be described in detail. A level is set in association with a numerical value for each parameter. For example, where the win ratio is 0.31, the win ratio level is 6, while where the ‘furikomi’ ratio is 0.125, the ‘furikomi’ ratio level is 7. The title assigning unit 161h first determines the levels regarding win ratio, ‘furikomi’ ratio, average number of ‘dora’ tiles and average number of exponentials based on a level determination table not shown. The title corresponding to the highest-level parameter is then assigned. Where the win ratio level is the highest, the player is determined to be a ‘quick win’ type of player and is assigned the title of ‘phoenix’. Where the ‘furikomi’ ratio level is the highest, the player is determined to be a ‘defense-first’ type player and is assigned the title of ‘turtle’. Where the average number of ‘dora’ tiles level is highest, the player is determined to be a luck-dependent type player and is assigned the title of ‘dragon’. Where the average number of exponentials level is highest, the player is determined to be an attack-minded player and is assigned the title of ‘tiger’. Each title indicates the name of a character that conveys an image of the player's characteristic game style (such as a ‘quick win’ approach).

The life evaluation unit 161k increases and decreases life in accordance with prescribed rules, and determines whether the amount of life is at or below a prescribed value. Specifically, 5000 HP (HP are the units by which life is measured) are virtually assigned to each player when a game begins, and the life value is increased or decreased based on the increase or decrease in the number of chips possessed by the player. For example, where the number of chips possessed by the player is reduced by 3000 points, the amount of life is reduced by 3000 HP, in proportion to the decrease in chips. Where the player's number of possessed chips increases by 3000 (3000×1), his number of HP is increased by 2400 (3000×0.8), in proportion to the amount of increase in chips. If the player's amount of life is 0 HP or less during a game, the player is prompted to insert one or more coins in order to continue playing. At the end of a game, it is checked whether or not the player has at least 5000 HP of life, and if he does not, he is prompted to insert one or more coins in order to continue playing. Even if the amount of life exceeds 5000 HP at the end of a game, the amount of life is reset to 5000 HP at the commencement of the next game.

The game achievement evaluation unit 161l determines the player's game achievement when a game ends by evaluating the operations of the player in the game based on prescribed rules. ‘Game achievement’ refers to the result of evaluation of the player's operations during the game. Specifically, the game achievement indicates as game results at the completion of a game the points represented by the chips possessed by each player, such points having increased or decreased between the beginning of the game and the end of the game.

The play continuation condition setting unit 161m sets a play continuation condition that must be met by each player in order to play the next game, based on the player's game achievement sought by the game achievement evaluation unit 161l. It sets the play continuation condition for the player at the end of a game by referring to the play continuation condition (the number of coins to be added or the like) for continuous participation that is associated with the player's game achievement value and is stored in the play continuation condition storage unit 162f described below.

The continuous participation permission unit 161n permits a player to participate in the next game subject to the play continuation condition set by the play continuation condition setting unit 161m, in response to the receipt of a request for continuous participation in the next game after the completion of the current game. The continuous participation permission unit 161n also has a function to allow, at the commencement of the next game in which a player participates on a continuous basis, the player to begin the next game without regard for the prescribed condition if the game achievement evaluation for the player performed by the game achievement evaluation unit 161l indicates a high level of achievement. Specifically, the continuous participation permission unit 161n checks at the end of a game whether or not the value for the number of chips possessed by the player is at least 25,000, and depending on the possessed chip value, prompts the player to insert one or more coins in order to continue to play. The number of coins set by the play continuation condition setting unit 161m described below is as follows. Where the player possesses 25,000 or more chips or points, the number of coins that must be inserted to continue playing is 0, where the player possesses between 15,000 and 24,900 chips or points, the number of coins that must be inserted to continue playing is 1, and where the player possesses between 0 and 14,900 chips or points, the number of coins that must be inserted to continue playing is 2. In addition, if the game achievement is reset when play is continued or when a game is over, each player's number of points possessed is reset to 25,000, and the next game begins.

The rank storage unit 162a associates with each player's name the number of items, which is assigned by the item assigning unit 161a and changed by the item transfer unit 161d, as well as the rank determined by the rank determination unit 161f, and stores these values in memory.

The history storage unit 162b stores as past game history data for each player the cumulative number of wins, i.e., the cumulative number of deals won by the player, the cumulative number of ‘furikomi’, i.e., the cumulative number of times the player has lost on his own discard, the cumulative number of deals played, the cumulative number of ‘dora’ tiles, i.e., the cumulative number of ‘dora’ tiles contained in the player's hand when the player has won, the cumulative number of exponentials, i.e. the cumulative number of ‘fan’ contained in the player's hand when the player has won, and the cumulative number of wins, i.e. the cumulative number of wins that have occurred.

The title storage unit 162c associates with each player's name and stores the parameter values calculated by the parameter calculation unit 161g and the title that is assigned to the player by the title assigning unit 161h.

The life storage unit 162d associates the life value calculated by the life evaluation unit 161k with each player's name and stores the name-associated value in memory.

The game achievement storage unit 162e associates the value representing the points represented by chips possessed by each player and evaluated (calculated) by the game achievement evaluation unit 161l with the player's name and stores the name-associated value in memory.

The play continuation condition storage unit 162f associates the play continuation condition that must be met by the player to participate in the next game on a continuous basis with the value representing the chips possessed by each player and sought by the game achievement evaluation unit 161l (the game achievement value) and stores the value-associated condition in memory.

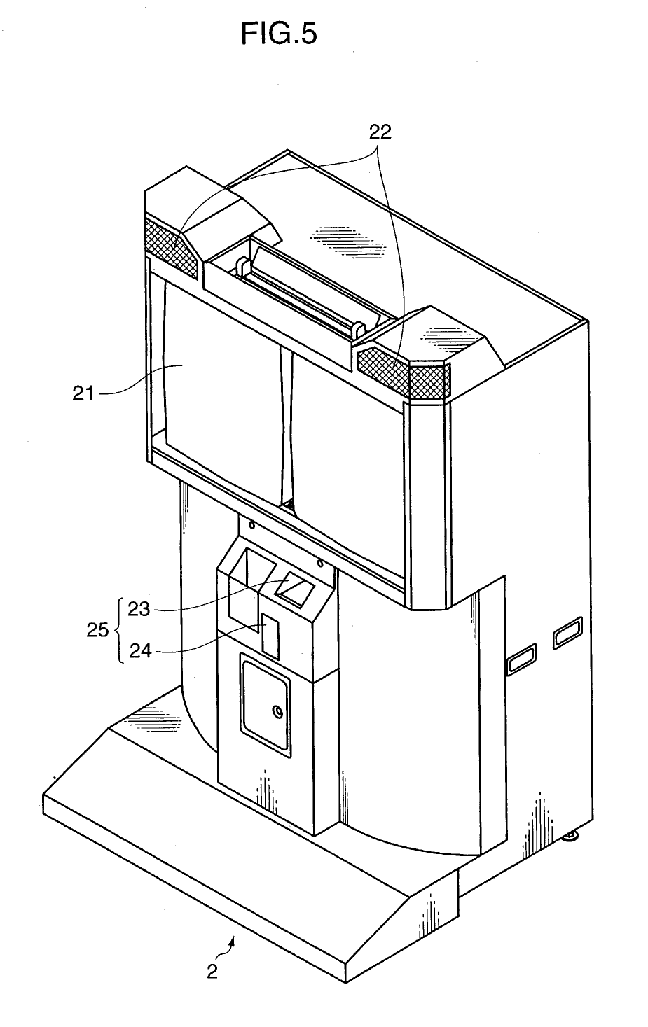

FIG. 5 is a perspective view of the external appearance of one embodiment of the arcade server device 2. The arcade server device 2 includes a monitor 21 that displays game screens and the like, a speaker 22 that outputs sounds, and a personal card vending machine 25 that receives coins inserted by players and sells personal cards.

In order to increase image display size, the monitor 21 is equipped with two cathode ray tubes, for example. The two cathode ray tubes are arranged such that the longer edges of their roughly rectangular image display areas that display their respective images are aligned with each other, and image signal control is performed such that the two image display areas display a single image.

The speaker 22 outputs prescribed messages and BGMs. The personal card vending machine 25 includes a coin receiving unit 24 that receives coins inserted by the player and a card expulsion outlet that expels the personal card. The coin receiving unit 24 also includes a coin ejection outlet (not shown in the drawings) that ejects inserted coins that are counterfeit, defective or otherwise unusable.

A controller 26 (see FIG. 2) comprising a microcomputer or the like that inputs detection signals from and outputs control signals to the various system components is located at an appropriate location within the arcade server device 2.

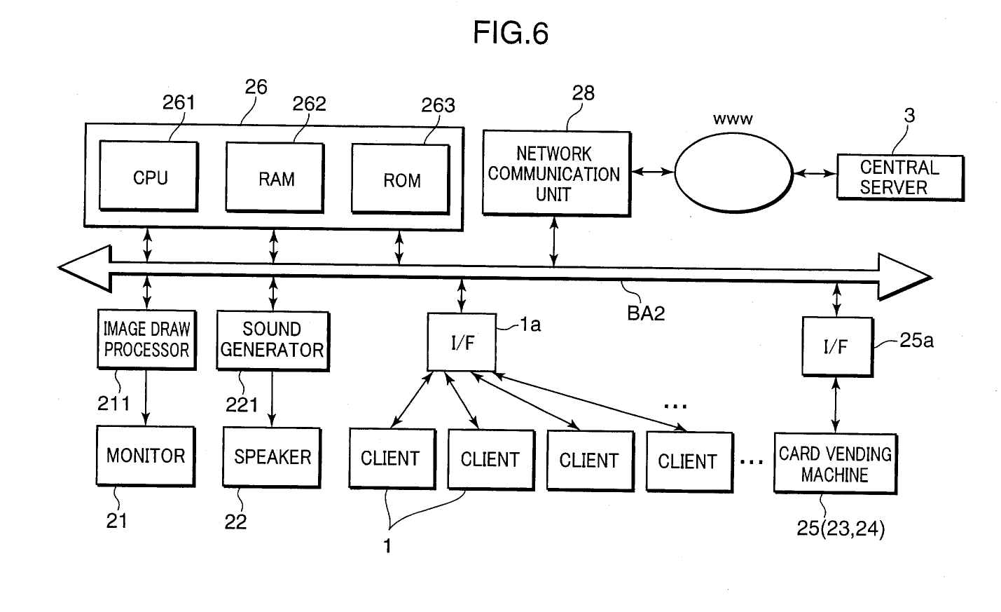

FIG. 6 is a hardware schematic diagram showing one embodiment of the arcade server device 2. The controller 26 controls the overall operation of the arcade server device 2, and includes a central processing unit (CPU) 261, a RAM 262 that temporarily stores information during the execution of processing, and a ROM 263 in which prescribed image information and other data are stored in advance.

The image draw processor 211 displays necessary images on the monitor 21 in accordance with image display commands from the controller 26, and includes a video RAM. The sound generator 221 outputs to the speaker 22 prescribed messages or BGMs in accordance with commands from the controller 26.

Among the various types of data stored in the ROM 263, data that can be stored on a detachable recording medium can be read using a driver of a hard disk drive, an optical disk drive, a flexible disk drive, a silicon disk drive, a cassette reader or the like, and in this case, the recording medium may comprise, for example, a hard disk, optical disk, flexible disk, CD, DVD, semiconductor memory or the like.

The network communication unit 28 enables the transmission and receipt of various types of data to and from the center server device 3 over a network comprising the Internet or the like. An interface unit 1a enables transmission of data to and from the plurality of (for example, eight) client terminal devices 1 connected to the arcade server 2.

The controller 26 sends via the interface unit 1a information, to which is assigned terminal identification information received from the center server device 3 via the network communication unit 28, to the client terminal device 1 corresponding to the terminal identification information. Information to which is assigned the terminal identification information received from a client terminal device 1 via the interface unit 1a is sent to the center server device 3 via the network communication unit 28.

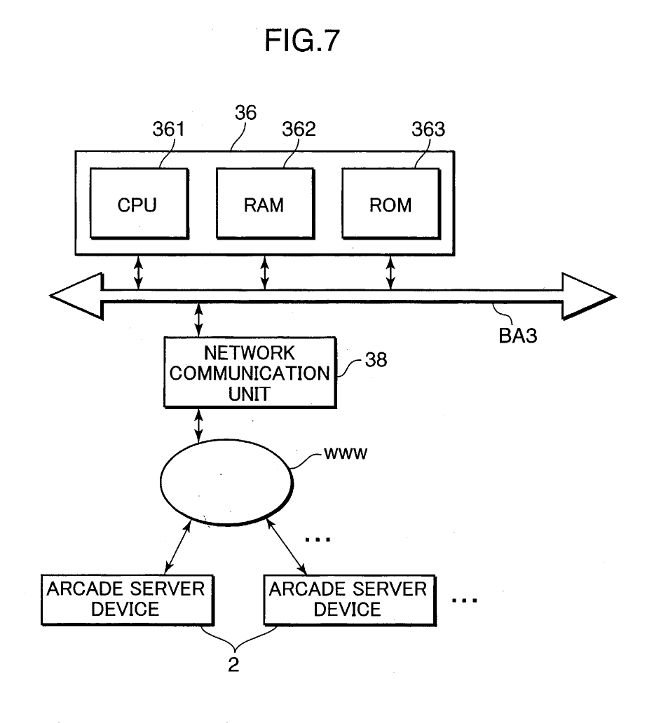

FIG. 7 is a hardware schematic diagram of one embodiment of the center server device 3 pertaining to the present invention. The controller 36 controls the overall operation of the center server device 3, and includes a central processing unit (CPU) 361, a RAM 362 that temporarily stores information during the execution of processing, and a ROM 363 in which prescribed image information and other data are stored in advance.

Among the various types of data stored in the ROM 363, data that can be stored on a detachable recording medium can be read using a driver of a hard disk drive, an optical disk drive, a flexible disk drive, a silicon disk drive, a cassette reader or the like, and in this case, the recording medium may comprise, for example, a hard disk, optical disk, flexible disk, CD, DVD, semiconductor memory or the like.

The network communication unit 38 enables the transmission and receipt of various types of data to and from the plurality of arcade server devices 2 over a network such as the Internet.

In addition, the game management program of the present invention is stored in the ROM 363, from which it is loaded into the RAM 362. The respective functions thereof are implemented through the sequential execution by the CPU 361 of the game management program loaded into the RAM 362.

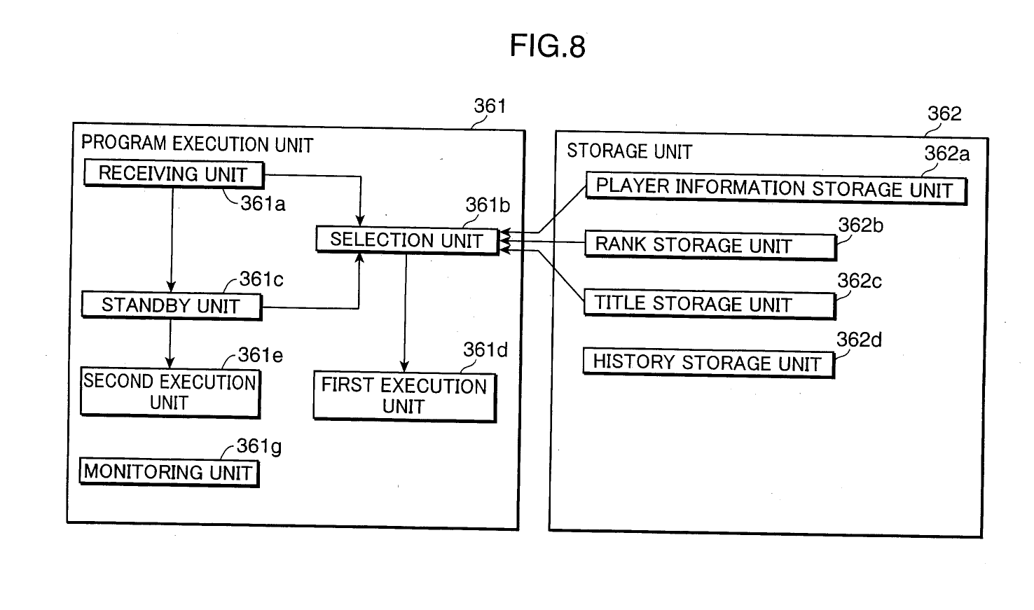

FIG. 8 is an example of a function block diagram of the controller 36 of the center server device 3. The CPU 361 of the controller 36 includes a receiving unit 361a that receives a request for game participation from each player when a game begins on each respective client terminal device 1, a selection unit 361b that selects according to prescribed rules a number of players to play in a shared game space from among the players whose game participation requests were received by the receiving unit 361a and the players that have been placed on standby status by the standby unit 361c described below, such number falling between a prescribed maximum (here, three) and a prescribed minimum (here, two), a standby unit 361c that places players who were not selected by the selection unit 361b on standby status and causes the selection unit 361b to perform player selection, a first execution unit 161d that executes a game among players selected by the selection unit 361b in a shared game space, a second execution unit 161e that executes a game among each player placed on standby status by the standby unit 361c and CPU players in a shared game space, and a monitoring unit 361g that monitors the state of use of all client terminal devices 1 selected by the selection unit 361b and on which a game is being executed by the first execution unit 161d.

The RAM 362 includes a player information storage unit 362a that stores personal information such as user ID data and fingerprint characteristic data, a rank storage unit 362b that stores rank information indicating the level of a player's skill in the game in association with the player's identification information (user ID data), a title storage unit 363c that stores title information indicating a player's game style in association with the player's identification information, and a history storage unit 362d that stores past game result information for the player, such as the cumulative number of wins, the cumulative number of ‘furikomi’ losses, the cumulative number of rounds played, the cumulative number of ‘dora’ bonus tiles played during wins, the cumulative number of ‘fan’ bonus tiles played during wins and the cumulative number of wins, in association with the player's identification information.

The receiving unit 361a receives personal information such as a player's user ID data and fingerprint characteristic data sent from each client terminal device 1, and receives requests for player game participation based on player information stored in the player information storage unit 362a. It also receives requests for game participation from players seeking to play on a continuous basis that are sent from each client terminal device 1.

The selection unit 361b selects 2 or 3 players who are to play in a shared game space from among the players whose game participation requests were received by the receiving unit 361a and the players placed on standby status by the standby unit 361c, based on the ranks stored in the rank storage unit 362b and the titles stored in the title storage unit 363c. The selection unit 361b also performs selection at least once more where the number of selected players is less than three (i.e., where only two players have been selected). Specifically, it selects opponents having a difference in rank relative to the player of no more than two grades and having the same title. For example, where the player has a rank of 5^{th} degree master and a title of ‘tiger’, players having a rank of between 3^{rd} and 7^{th} degree master and the title of ‘tiger’ are selected as the opponents to play in the shared game space. Where a player placed on standby status by the standby unit 361c is selected by the selection unit 361b, notification of this selection is given via the display of such selection on the screen of the monitor 11 of the client terminal device 1 of the selected player as a message. While notification is given via screen display in this description, notification may also be given via sound output or via the illumination (or flashing) of a prescribed lamp.

Where a player is not selected by the selection unit 361b, the standby unit 361c places the player on standby status and causes the selection unit 361b to perform player selection. Standby status is a state in which the player is waiting to be selected as an opponent by the selection unit 361b.

The first execution unit 161d executes a game in a shared game space between players selected by the selection unit 361b. In other words, it sends to the client terminal devices 1 being used by the selected players command information commanding the execution of a game with opponents (i.e., players that are ‘sitting’ at the same virtual table) that were selected by the selection unit 361b and have a difference in rank of no more than two grades and the same title.

The second execution unit 161d executes a game in a shared game space between each player placed on standby status by the standby unit 361c and CPU players. In other words, where a player has not been selected by the selection unit 361b, it sends to the client terminal device being used by the non-selected player command information commanding that a game be executed between the non-selected player against CPU players until the non-selected player is selected by the selection unit 361b.

The monitoring unit 361g monitors the state of use of all client terminal devices that were selected by the selection unit 361g and on which a game is being executed by the first execution unit 161d, and where a player quits a game for some reason during the game, sends a notification to the client terminal devices 1 for the remaining players in that game indicating that the remainder of the play will be carried out by a CPU player in place of the quitting player.

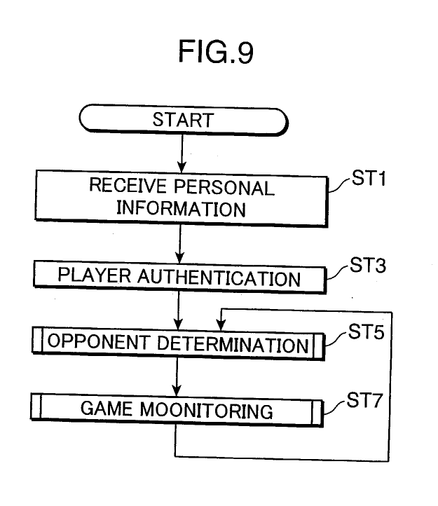

FIG. 9 is an example of a flow chart showing the operations of the center server device 3. First, personal information sent from the client terminal device 1 is received (step ST1), and the player corresponding to the sent personal information is permitted to join a game based on the player information stored in the player information storage unit 362a (step ST3). Two or more players are then selected by the selection unit 361b to play in a shared game space from among players whose game participation requests were received by the receiving unit 361a and who were permitted to participate (and who did not designate ‘One player’ mode described below), based on the rank information stored in the rank storage unit 362b and the title information stored in the title storage unit 363c, and command information commanding that a game be executed in a shared game space by the first execution unit 161d between the players selected by the selection unit 361b is sent to the client terminal device 1 for each of the selected players (step ST5). The status of use of all client terminal devices 1 on which a game is being executed by the first execution unit 161d is then monitored by the monitoring unit 361g, and where a player quits the game for some reason during the game, a notification is sent to the client terminal devices 1 for the remaining players in that game indicating that the remainder of the play will be carried out by a CPU player in place of the quitting player (step ST7).

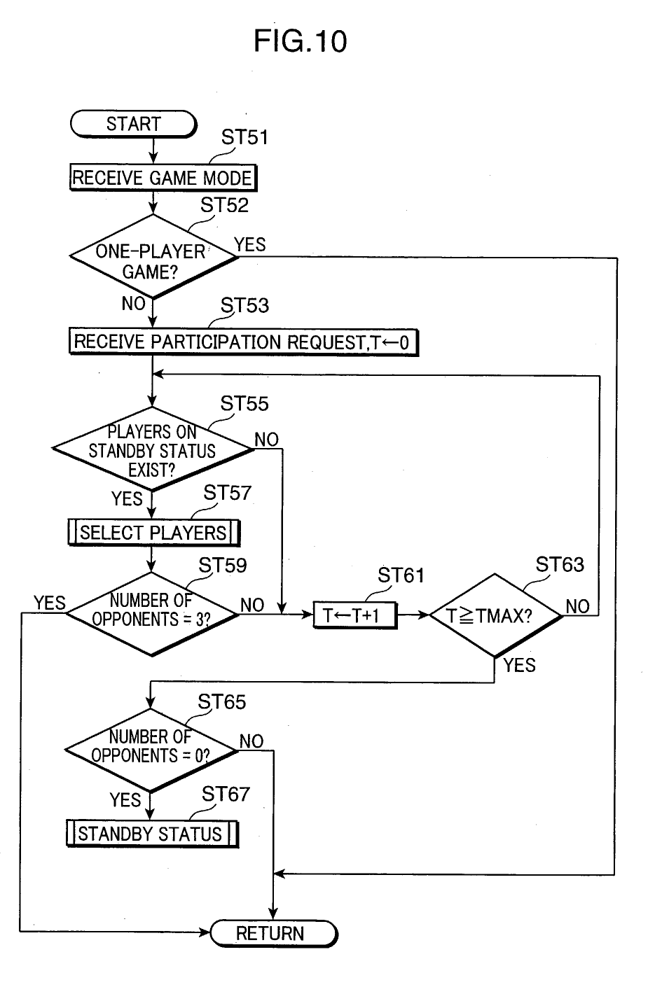

FIG. 10 is an example of a detailed flow chart of the step ST5 (player determination routine) shown in FIG. 9. Unless otherwise indicated, the routine below is carried out by the selection unit 361b. First, the game mode sent from the client terminal device 1 is received by the receiving unit 361a (step ST51). The three game modes of ‘One-player game’, ‘Match game’ or ‘Online game’ exist. ‘One-player game’ mode is a game mode in which the player plays against CPU players, ‘Match game’ mode is a game mode in which all players are using client terminal devices 1 connected to the same arcade server device 2, and ‘Online game’ mode is a game mode in which at least one of the players is using a client terminal device 1 that is connected to a different arcade server device 2 than that to which the other players are connected.

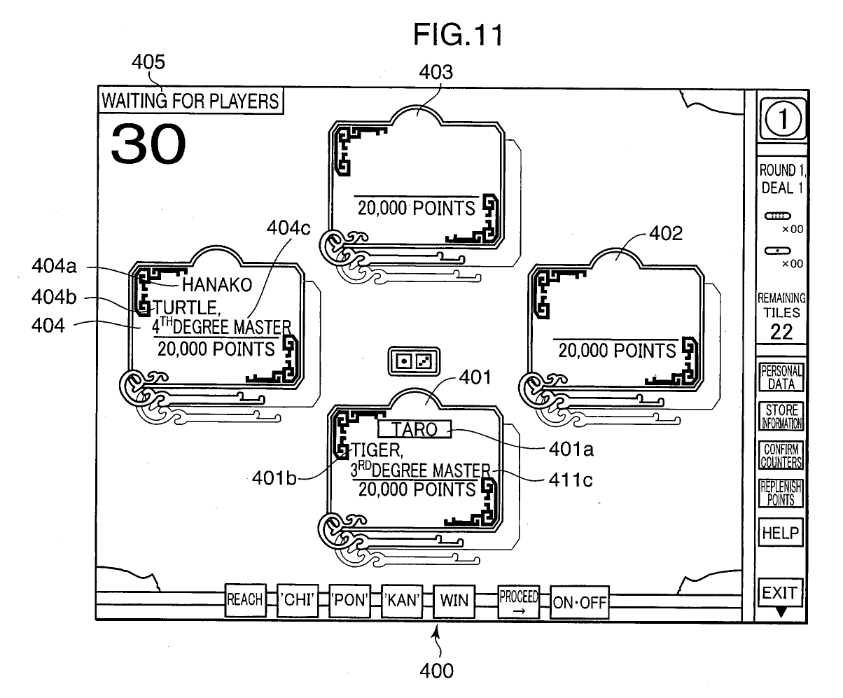

It is then determined by the receiving unit 361a whether or not the game mode is ‘One-player’ mode (step ST52). If the answer is positive, the sequence returns to the main routine. If the answer is negative, the player request is received, a time counter T is initialized at ‘0’ (step ST53), command information is sent to the client terminal device 1 for the player commanding that the idle screen shown in FIG. 11 be displayed.

FIG. 11 is a example of a screen drawing of an idle screen. In the idle screen 400, player information 401 for the player to whom the screen is being displayed is shown at the bottom part of the screen, player information 402 and 403 indicating that no opponents have been selected is shown at the right side of the screen and the top of the screen, respectively, and player information 404 for a CPU player is shown at the left side of the screen. Names 401a and 404a comprising the players' nicknames within the game, player titles 401b and 404b, and player ranks 401c and 404c are displayed as well. For example, the name of the CPU player is ‘Hanako’, the title is ‘turtle’, and the rank is ‘4^{th} degree master’. Because player information 402 and 403 for the players⁽⁶⁾ other than the player using the client terminal device 1 on which this screen is being displayed and the CPU player are not being displayed on the idle screen 400, the player can see that no opponents have been selected.

The flow chart in FIG. 10 will now be returned to for further explanation. It is determined whether or not there exist players who have been placed on standby status by the standby unit 361c or players whose game participation requests have been received (step ST55). If this determination is negative, the sequence advances to step ST61, while if the determination is positive, two or three players who are to play in a shared game space are selected from among the players whose game participation requests have been received by the receiving unit 361a and the players placed on standby status by the standby unit 361c, based on the rank information stored in the rank storage unit 362b and the title information stored in the title storage unit 363c (step ST57), and command information commanding the display of an idle screen reflecting the result of the selection is sent to the client terminal device 1 of the player.

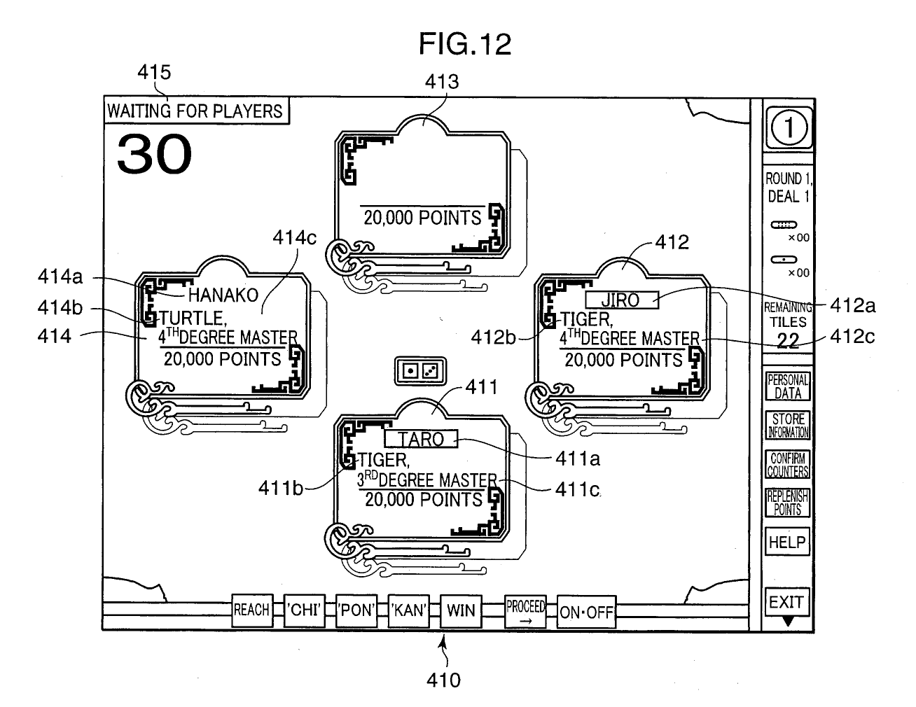

FIG. 12 is an example of an idle screen showing the result of the selection. In the idle screen 410, player information 411 for the player to whom the screen is being displayed is shown at the bottom part of the screen, player information 413 indicating that no opponents have been selected is shown at the top of the screen, player information 414 for a CPU player is shown at the left side of the screen, and player information 412 for the player selected by the selection unit 361b is displayed at the right side of the screen. Displayed in the player information 411, 412 and 414 respectively are names 411a, 412a and 414a comprising the nicknames of the players in the game, player titles 411b, 412b and 414b, and player ranks 411c, 412c and 414c. Because the player information 412 for the player (opponent) selected by the selection means 361b is displayed on the idle screen 410 in addition to player information for the player using the client terminal device 1 on which this screen is being displayed and the CPU player, the player using the client terminal device 1 on which this screen is being displayed can see that one opponent has been selected.

The flow chart in FIG. 10 will be returned to once more for further explanation. It is determined whether or not the number of players selected in step ST57 (the number of opponents) is ‘3’ (step ST59). If this determination is positive, the sequence returns to the main routine, while if the determination is negative, the time counter T counts up by one increment (step ST61), and it is determined whether or not the time counter T has counted to a prescribed time TMAX (here, 30 seconds) (step ST63). If this determination is negative, the sequence returns to step ST53, while if the determination is positive, it is determined whether or not the number of players selected in step ST57 is ‘0’ (i.e., whether no players have been selected) (step ST65). If this determination is positive, the player is placed on standby status by the standby unit 361c (step ST67), while if the determination is negative, the sequence returns to the main routine.

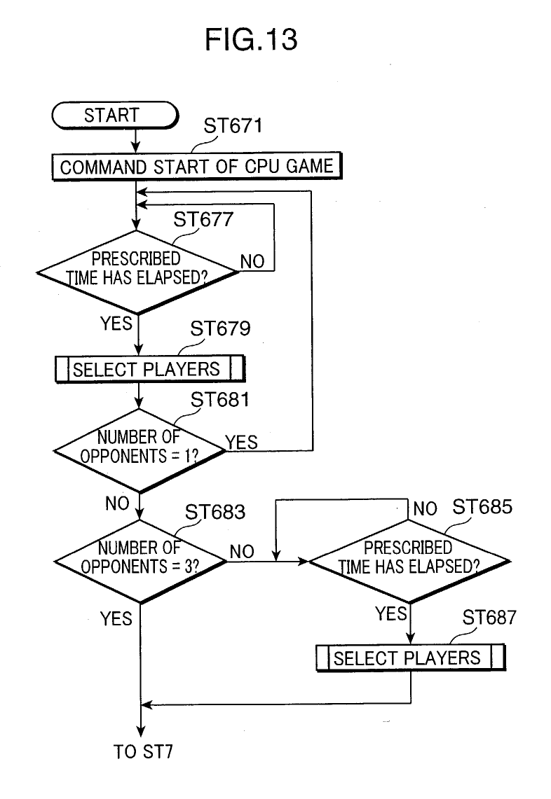

FIG. 13 is an example of a detailed flow chart of the routine (standby status routine) of step ST67 shown in FIG. 10. Unless otherwise specified, the routine is executed by the standby unit 361c. First, command information commanding that a CPU game (a game with only CPU players as opponents) begin is sent to the client terminal device 1 (step ST671).

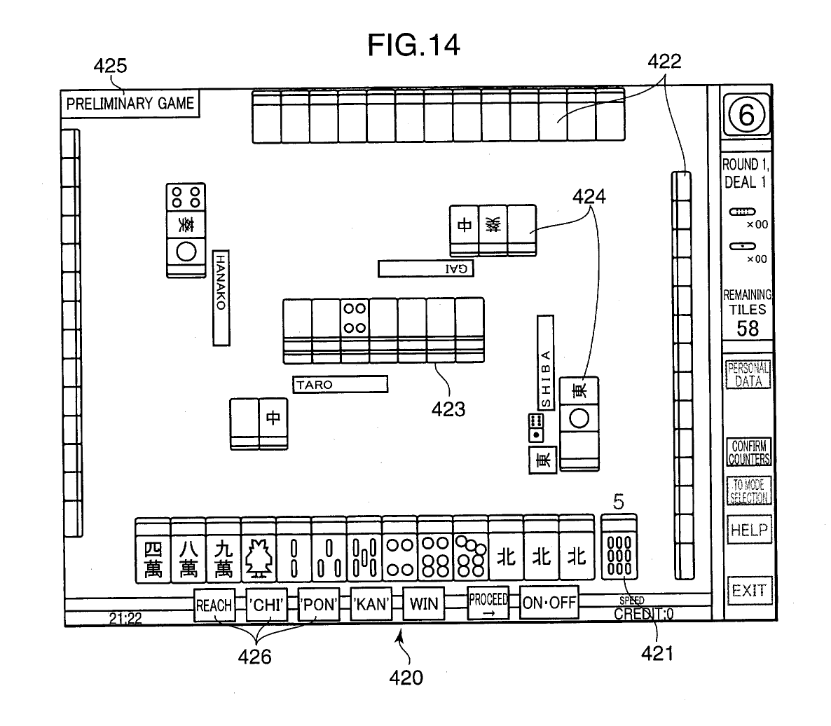

FIG. 14 is an example of a screen drawing of a preliminary game screen representing the screen for a CPU game. The player's hand tiles 421 are displayed near the bottom of the preliminary game screen 420 such that the types of tiles can be seen, the opponents' hand tiles 422 are displayed at the top and sides of the screen such that the types of tiles cannot be seen, a dead wall 423 that includes ‘dora’ bonus tiles is displayed in roughly the center of the screen, discard tiles 424 are displayed around the periphery of the dead wall 423, various player-operated buttons 426 are displayed at the bottom of the screen, and a message 425 stating ‘Preliminary game’, which indicates that the player has been placed on standby status and is playing a CPU game, is displayed at the upper left-hand corner of the screen. The player can see from the message 425 displayed in the preliminary game screen 420 that the player has been placed on standby status and is playing a CPU game.

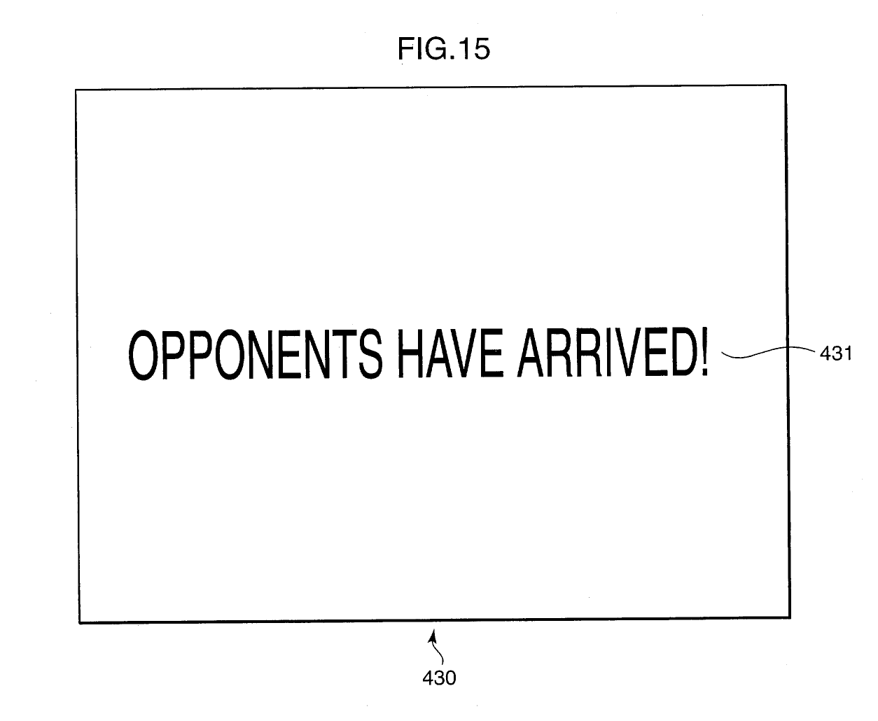

The flow chart shown in FIG. 13 will now be returned to for further explanation. It is determined whether or not a prescribed period of time (for example, 30 seconds) has elapsed (step ST677), and time is counted up until this determination is positive. Where this determination is positive, player selection is performed by the selection unit 361b (step ST679) and it is determined whether or not the player who was placed on standby status has been selected (step ST681). If this determination is positive, the sequence advances to step ST683 in which command information commanding the display of the opponent advent screen shown in FIG. 15 and indicating that player selection has been performed by the selection unit 361b is sent to the client terminal device 1. If the determination is negative, the sequence returns to step ST677.

FIG. 15 is an example of a screen drawing of an opponent advent screen. A message 431 stating ‘Opponents have arrived!’, indicating that a player who had been placed on standby status has been selected is displayed on the opponent advent screen 430. Because the player who had been placed on standby status was placed on standby status because player selection was not performed by the selection unit 361b, regardless of the fact that the player selected a game with other players (i.e., regardless of the fact that ‘Match game’ mode or ‘Online game’ mode was selected as the game mode), the selection of the player by the selection unit 361b is recognized as the advent of opponents for the player. Accordingly, the player can see from the message 431 stating ‘Opponents have arrived!’ that is displayed on the opponent advent screen 430 that the player has been selected (i.e., that a game with other players will soon begin).

The flow chart shown in FIG. 13 will once again be returned to for further explanation. If the determination in step ST681 is positive, it is determined whether or not the number of players selected is ‘3’ (step ST683). If this determination is positive, the sequence advances to step ST7 shown in FIG. 9 (the game monitoring routine), while if the determination is negative (i.e., if the number of players selected is ‘1’), it is determined whether or not a prescribed amount of time (for example, 10 seconds) has elapsed (step ST685), and the elapsed time is counted until this determination is positive. When the determination is positive, player selection is performed by the selection unit 361b (step ST687) and the sequence advances to step ST7 shown in FIG. 9 (i.e., the game monitoring routine).

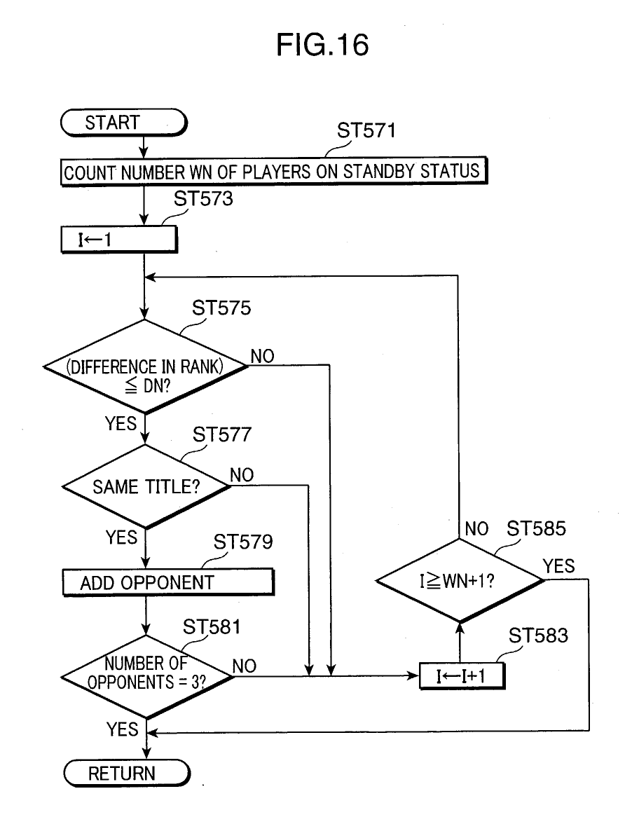

FIG. 16 is an example of a detailed flow chart of the routine of step ST57 shown in FIG. 10 (the player selection routine). The routine of step ST57 shown in FIG. 10 is identical to the routines of steps ST679 and ST687 shown in FIG. 13. Furthermore, the routine described below is executed entirely by the selection unit 361b. First, the total number WN of players on standby status and players whose game participation requests have been received is counted (step ST573). The number of players counter I is then initialized to ‘1’ (step ST573). The ranks of the player and of the i^{th} player are read from the rank storage unit 362b, and it is determined whether or not the difference in rank is equal to or lower than a prescribed value DN (here, ‘2’) (step ST575). If this determination is negative, the sequence advances to step ST583, while if the determination is positive, the titles of the player and of the i^{th} player are read from the title storage unit 363c, and it is determined whether or not the titles are the same (ST577). If this determination is negative, the sequence advances to step ST583, while if the determination is positive, the i^{th} player is added to the players who are to play the player (step ST579).

Next, it is determined whether or not the number of players who are to play the player is ‘3’ (step ST581). If this determination is positive, the sequence returns to the main routine, while if it is negative, or if the determinations in steps ST575 or ST577 were negative, the number of players counter I counts up by one increment (step ST583), and it is determined whether or not the number of players counter I has exceeded a total number of players WN (step ST585). If this determination is positive, the sequence returns to the main routine, while if it is negative, the sequence returns to step ST575.

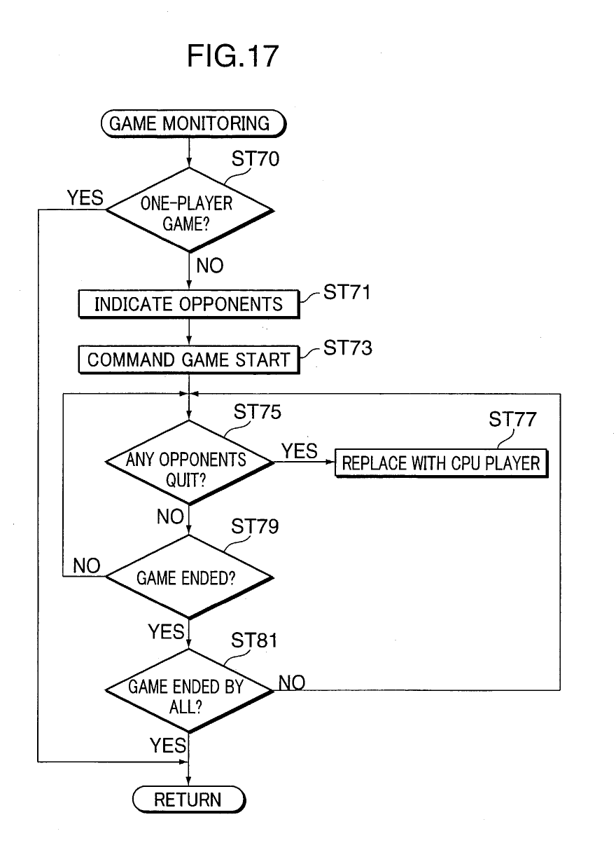

FIG. 17 is an example of a detailed flow chart of the routine (game monitoring routine) of step ST7 shown in FIG. 9. Unless otherwise specified, the routine is executed by the monitoring unit 361g. First, it is determined whether or not the game mode is ‘One-player’ mode (step ST70). If this determination is positive, the sequence returns to the main routine, while if the determination is negative, command information commanding that opponents be specified is sent to each client terminal device 1 (step ST71). The terminal devices 1 to which this command information is sent are termed monitored terminals.

Command information commanding the commencement of a game is then sent to the monitored terminals by the first execution unit 361d (step ST73). It is then determined whether or not game interruption information indicating interruption of the game during play has been received from any of the monitored client terminals (step ST75). If this determination is negative, the sequence advances to step ST79, while if it is positive, the client terminal device 1 that sent the game interruption information is excluded from the monitored terminals and opponent change command information is sent to the client terminal devices 1 for the other players who are playing in the same game space as the player playing on that terminal (hereinafter termed the ‘excluded player’), commanding that a CPU player be substituted for the excluded player (step ST77).

It is then determined whether or not game end information indicating that the game has ended has been received from any client terminal device 1 (step ST79). If this determination is negative, the sequence returns to step ST75, while if it is positive, the client terminal device from which the game end information was sent is excluded from the monitored terminals, and it is determined whether or not game end information or game interruption information was received from all monitored terminals (i.e., whether the number of monitored terminals became ‘0’) (step ST81). If this determination is negative, the sequence returns to step ST75, while if it is positive, the sequence returns to the main routine.

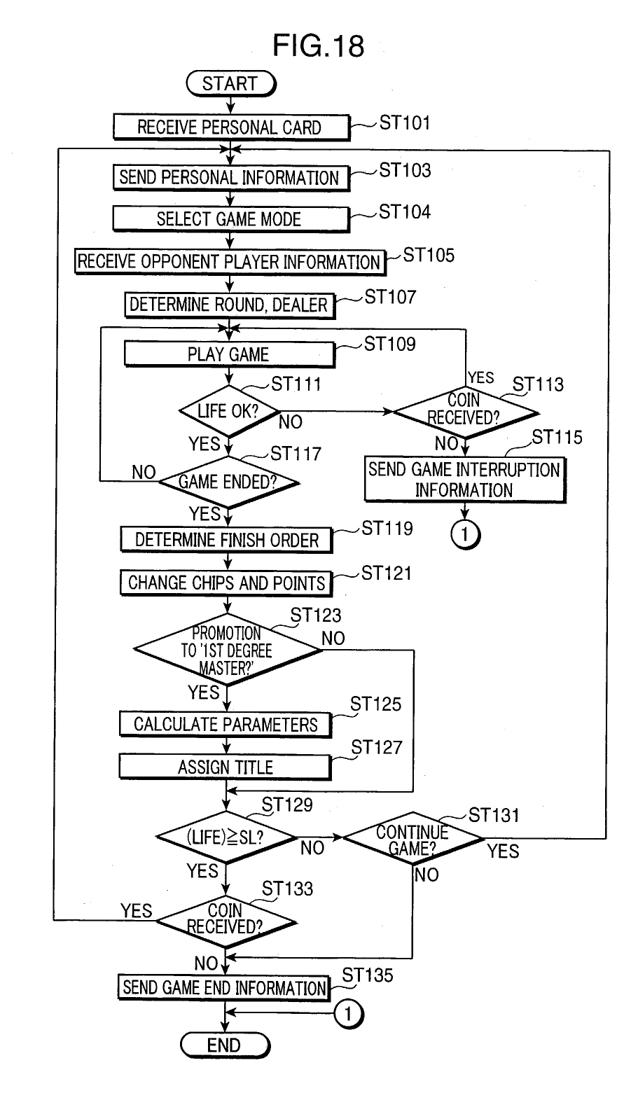

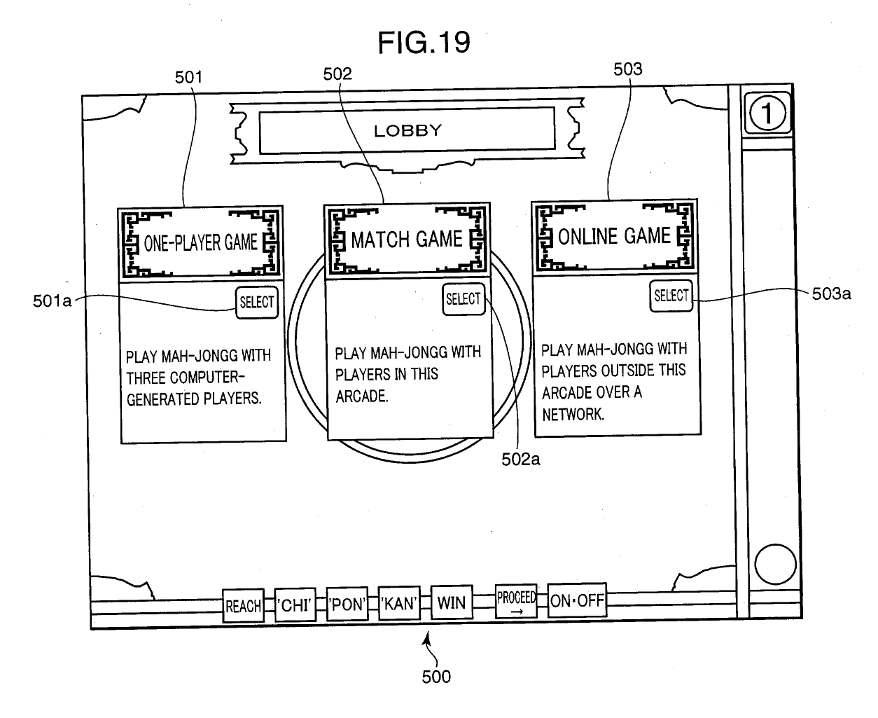

The operations of the client terminal device 1 executed based on commands from the central server 3 described above will now be explained. FIG. 18 is an example of a flow chart showing the operations of the client terminal device 1. First, user ID data from the personal card inserted in the card reader 13 is read, the fingerprint of the player is imaged by the CCD camera 14a of the fingerprint verification unit 14, and the characteristic data needed for personal authentication is extracted by the fingerprint verification unit 14 using the fingerprint information obtained from the CCD camera 14a (step ST101). The user ID and the characteristic data are then sent to the center server device 3 (step ST103). The mode selection screen shown in FIG. 19 from which to select the game mode is displayed, the game mode is selected based on the receipt of player input (step ST104), and game mode information is sent to the center server device 3.

FIG. 19 is an example of a screen drawing of a game mode selection screen from which to select the game mode. A ‘One-player game’ selection area 501 including a ‘Choose’ button that is pressed in order to select the ‘One-player game’ mode is displayed at the left side of the mode selection screen 500, a ‘Match game’ selection area 502 that includes a ‘Choose’ button 502a that is pressed in order to select ‘Match game’ mode is displayed in the center of the screen, and an ‘Online game’ selection area 503 that includes a ‘Choose’ button 503a that is pressed in order to select ‘Online game’ mode is displayed at the right side of the screen. The player can select the desired game mode by pressing the ‘Choose’ button 501a through 503a for that game mode.

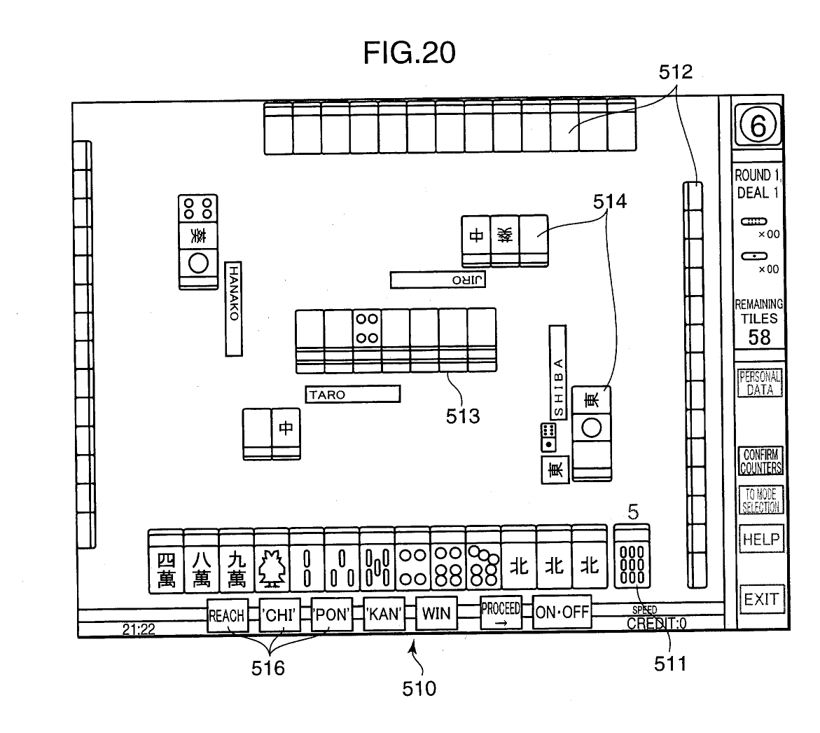

The flow chart of FIG. 18 will now be returned to for further explanation. Opponent information for the other players (opponents) who will play a game in the same game space as the player, such as the name, rank and title, are received from the center server device 3 (step ST105). Command information commanding the execution of a game is received from the center server device 3, the game is begun, and the round and the dealer are determined (step ST107). The virtual game tiles are then ‘dealt’ (step ST109), and the game play screen shown in FIG. 20 is displayed.

FIG. 20 is an example of a screen drawing of a game play screen showing the game situation. The player's hand tiles 511 are displayed near the bottom of the game play screen 510 such that the types of tiles can be seen, the opponents' hand tiles 512 are displayed at the top and sides of the screen such that the types of tiles cannot be seen, a dead wall 513 that includes ‘dora’ bonus tiles is displayed in roughly the center of the screen, discard tiles 514 are displayed around the periphery of the dead wall 513, and various player-operated buttons 516 are displayed at the bottom of the screen. The player plays the game by pressing the appropriate buttons 526 while viewing the game play screen 510.

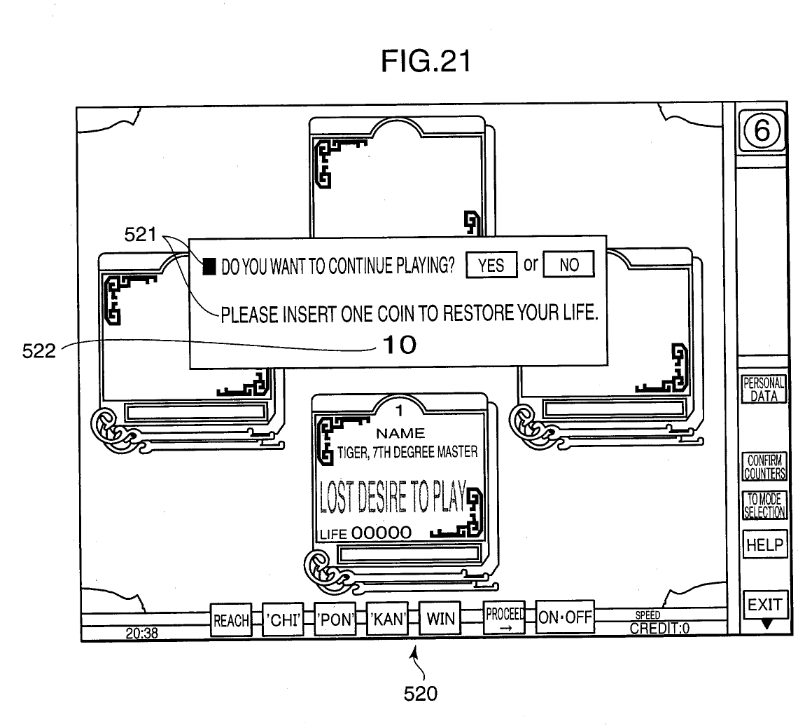

FIG. 18 will now be returned to for further explanation. When the deal begins, the amount of life is calculated by the life evaluation unit 161k, and it is determined whether or not the amount of life exceeds 0 HP (i.e., is 1 HP or higher) (step ST111). If this determination is positive, the sequence advances to step ST117, while if it is negative, the play continuation selection screen shown in FIG. 21 prompting the player to decide whether or not to continue the game is displayed, and the player's decision is received based on whether or not coins were received in the coin receiving unit 15, whereby it is determined whether or not the current game will be continued (step ST113). If this determination is negative, game interruption information comprising information indicating that the game will be discontinued is transmitted to the center server device 3 (step ST115), and the routine ends, while if the determination is positive, the sequence returns to step ST109.

FIG. 21 is an example of a screen drawing of a play continuation selection screen. A message 521 stating ‘Do you want to continue playing? Please insert one coin and restore your life count.’, and prompting the player to decide whether or not to continue the game, i.e., whether or not to insert one or more coins (here, one coin), is displayed in roughly the center of the screen, together with a time display area 522 that displays the time limit for making the decision by counting down from a prescribed period of time (here, 10 seconds). From reading the play continuation selection screen 520, the player can see that if he wishes to continue playing, he must insert a coin before the remaining time displayed in the time display area 522 reaches ‘0’.

Returning to the flow chart shown in FIG. 18, if the determination in step ST111 is positive, it is determined whether or not the game has ended (step ST117). If this determination is negative, the sequence returns to step ST109, while if it is positive, game end information indicating that the game has ended is sent to the center server device 3, and the game finish order is determined by the performance determination unit 161b (step ST119). A certain number of items virtually possessed by the players are transferred among the players by the item transfer unit 161d based on the result of the determination by the performance determination unit 161b and the number of rounds selected by the table selection unit 161c (step ST121). The player's rank indicating the level of his skill in the game is then determined by the rank determination unit 161f based on the number of items and points virtually possessed by the player, and it is determined by the rank determination unit 161f whether or not the player's rank has changed to ‘1^{st} degree master’ through comparison of the player's new rank and the player's prior rank (as of the end of the previous game) stored in the rank storage unit 162a. (step ST123). Where the player's rank has not changed to ‘1^{st} degree master’, an item display screen omitted from the drawings that shows the current number of items is displayed, and the sequence advances to step ST129. The rank determined by the rank determination unit 161f is stored in the rank storage unit 162a and is sent as rank information to the center server device 3.

If the player's rank has changed to ‘1^{st} degree master’, parameters indicating the characteristics of the player's games are calculated by the parameter calculation unit 161g (step ST125). A title for the player in the game is then virtually assigned by the title assigning unit 161h based on the parameters calculated by the parameter calculation unit 161g (step ST127), and this title is stored in the title storage unit 162c and title information is sent to the center server device 3.

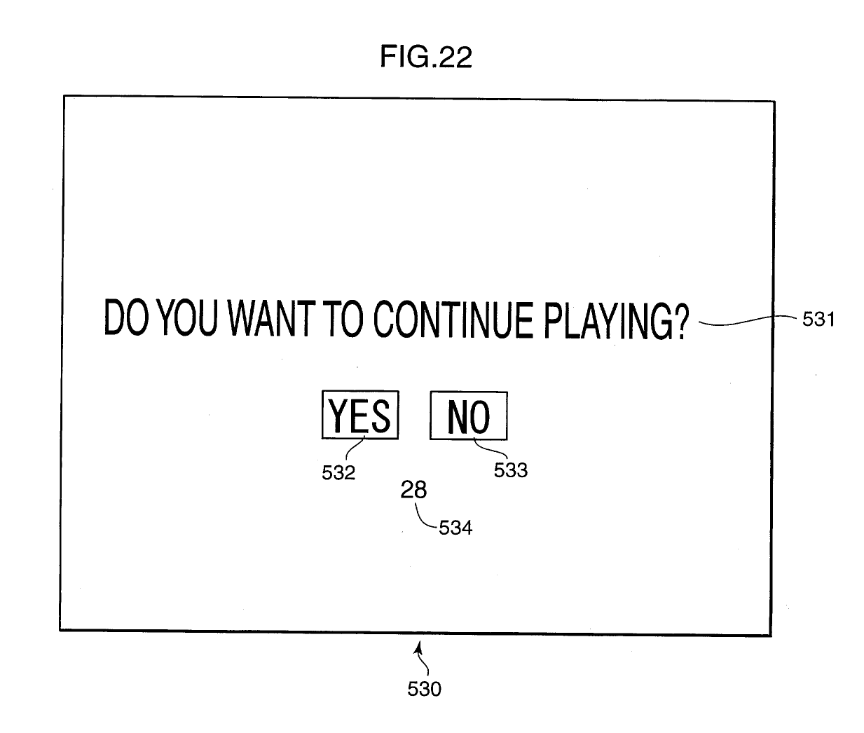

It is then determined whether or not the current amount of life HP equals or exceeds the prescribed value SL (here, 500 HP) required in order to continue the game (step ST129). If this determination is positive, the play continuation selection screen shown in FIG. 22 is displayed, and it is determined based on the receipt of player input whether or not the game is to be continued (step ST131). If this determination is positive, the sequence returns to step ST103, while if it is negative, the sequence advances to step ST135.

FIG. 22 is an example of a screen drawing of a play continuation selection screen. A message 531 stating ‘Do you want to continue playing?’ and prompting the player to input a decision regarding whether or not to continue playing the game is displayed in roughly the center of the screen, a ‘YES’ button 532 that is pressed by the player when the game is to be continued and a ‘NO’ button 533 that is pressed by the player when the game is not to be continued are displayed below the message 531, and a time display area 534 displays the time limit for making the decision by counting down from a prescribed period of time (here, 30 seconds) is located below these buttons. Before the remaining time displayed in the time display area 534 reaches ‘0’, the player indicates his desire to continue the game by pressing the ‘YES’ button 532 on the play continuation selection screen 530, and indicates his desire not to continue the game by pressing the ‘NO’ button 533 on the play continuation selection screen 530. If the player fails to press either the ‘YES’ button 532 or the ‘NO’ button 533 before the remaining time reaches ‘0’, the ‘NO’ button 533 is deemed to have been pressed.

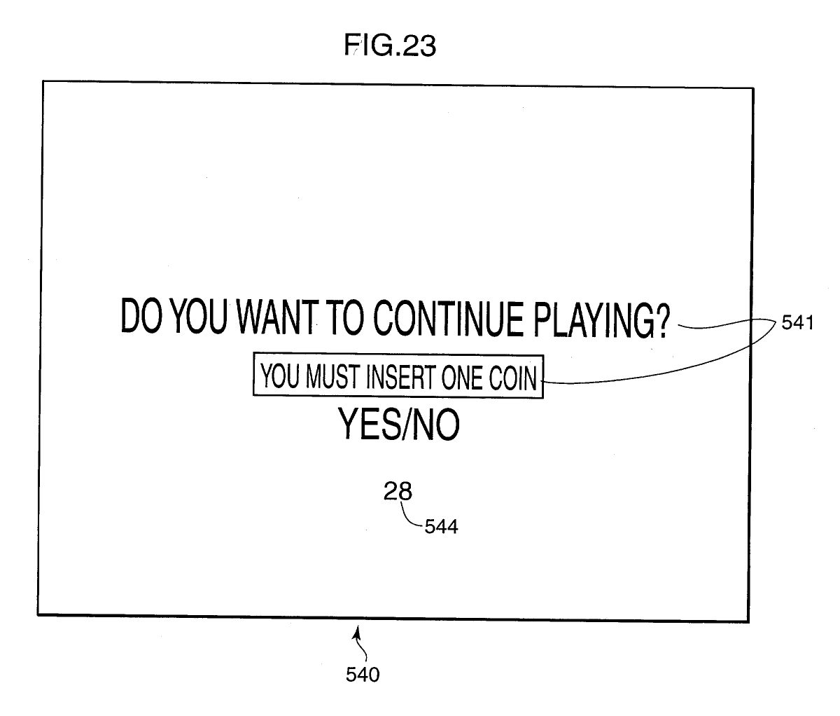

Returning to the flow chart shown in FIG. 18, if the determination in step ST129 is negative, the play continuation selection screen shown in FIG. 23 is displayed and a decision by the player is received regarding continuation of the game based on whether or not a coin has been received in the coin receiving unit 15 (step ST133). If this determination is positive, the sequence returns to step ST103, while if it is negative, the sequence advances to step ST135.

FIG. 23 is an example of a screen drawing of a play continuation selection screen. A message 541 stating ‘Do you want to continue playing? Please insert one coin.’ and prompting the player to decide whether or not to continue playing the game, i.e., whether or not to insert one or more coins (here, one coin) and a time display area 544 that displays the time limit for making the decision by counting down from a prescribed period of time (here, 30 seconds) are displayed in roughly the center of the screen. From reading the play continuation selection screen 540, the player can see that if he wishes to continue playing, he must insert a coin before the remaining time displayed in the time display area 544 reaches ‘0’.

Returning once more to the flow chart of FIG. 18, where the determination of step ST133 or the determination of step ST131 is negative, game end information indicating that the game has ended is sent to the center server device 3 (step ST135), and the routine ends.

Because the amount of life possessed by the player during the game is increased and decreased and it is determined whether or not this amount of life equals or exceeds 5000 points, a player determined to have fewer than 5000 points of life by the life evaluation unit 161k is removed from the game, but can reinstate himself into the game space by adding an additional coin, for example. As a result, a player who has lost and been removed from the game can be encouraged to continue playing in the game because the frustration that the player feels from the loss serves as motivation for play continuation. Therefore, because a mechanism exists by which a player who has lost and been removed from the game can prevent his removal from the game space, players can be assured of being allowed to continue playing and the rate of use of the client terminal devices 1 (i.e. the game terminals), as well as the accompanying revenues, can be increased. Furthermore, because players who have been determined to possess at least 5000 points of life at the end of the game are given the right to continue playing in the next game, the possibility of earning this right serves as motivation for the player, enabling a highly interesting game to be provided.

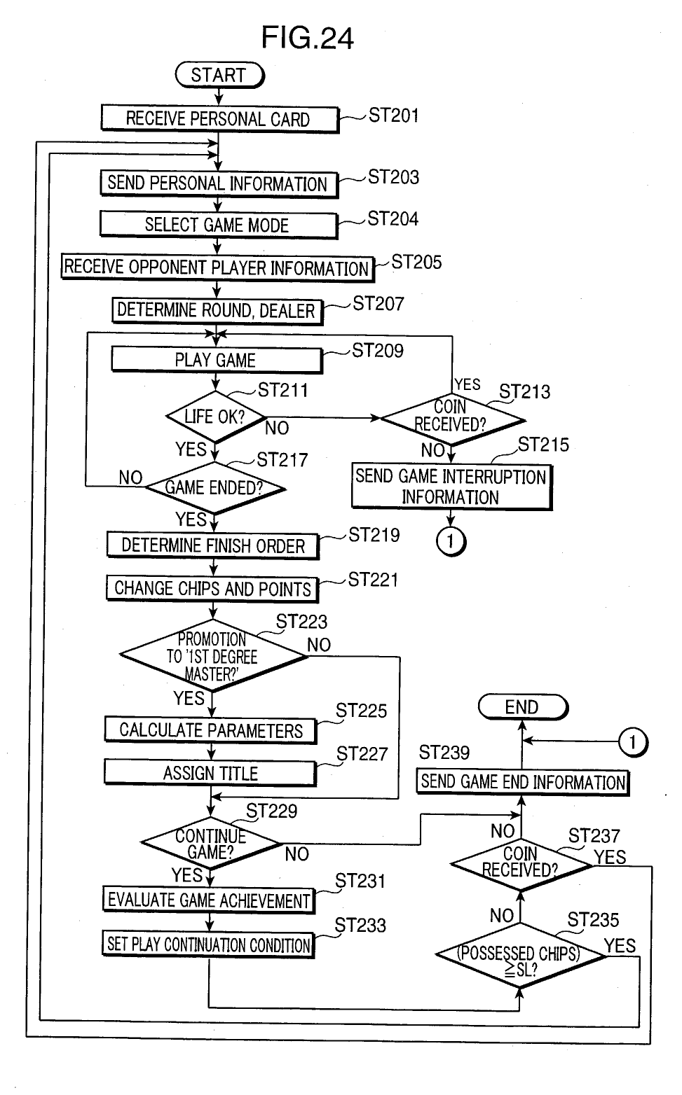

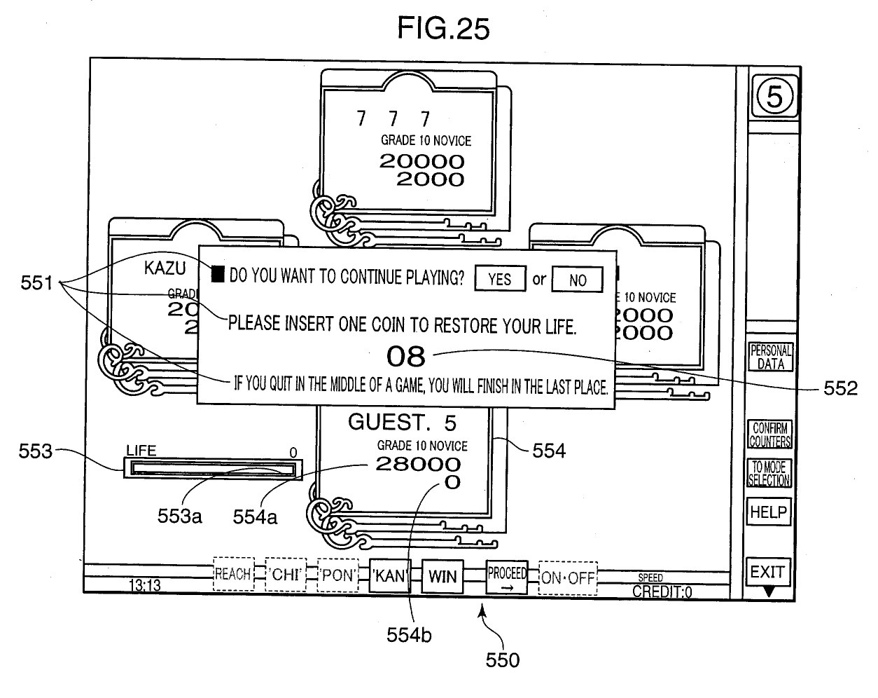

Other operations of the client terminal device 1 executed based on commands from the center server device 3 described in the flow chart shown in FIG. 18 will now be described. FIG. 24 is an example of a flow chart showing the operations of the client terminal device 1. Unless otherwise specified, the operations below are executed by the game achievement evaluation unit 161l. Furthermore, because the steps ST201 through ST227 shown in FIG. 24 are identical to the steps ST101 through ST127 shown in FIG. 18, except that the screen shown in FIG. 25 described below that is displayed on the monitor 11 of the client terminal device 1 where the determination in step ST211 is ‘NO’ is different from the screen shown in FIG. 22 that is displayed where the determination in step 111 is ‘NO’, these steps will not be described below, and only the steps beginning with ST229 will be described in detail.

First, the routines executed in order to continue play in response to upward or downward fluctuations in a player's life points during the game will be described.

The situation where the determination in step ST211 in the flow chart shown in FIG. 24 is ‘NO’ will first be described. When a game begins, the player's amount of life is calculated by the life evaluation unit 161k, it is determined whether or not the amount of life exceeds 0 HP (i.e., is 1 HP or higher) (step ST211), and if this determination is negative (‘NO’ in step ST211), the play continuation selection screen shown in FIG. 25 prompting the player to decide whether or not to continue the game is displayed.

FIG. 25 is an example of a screen drawing of a play continuation selection screen. A message 551 stating ‘Do you want to continue playing? Please insert a coin to restore your life count. If you quit in the middle of the game, you will finish in the last place.’, and prompting the player to decide whether or not to continue the game, i.e. whether or not to insert a coin, a life gauge 553 that rises or falls in response to the player's progress in the game, a time display area 552 that displays the time remaining for making the decision by counting down from a prescribed amount of time (here, 10 seconds), and a possessed chips area 554 that shows the number of chips currently possessed by the player, are displayed in roughly the center of the screen. The life gauge 553 includes a life bar 553a, which fluctuates in length in response to number of chips possessed by the player. Here, because the player has 0 HP of life, the life bar 553 displays 0 HP as well. By referring to the play continuation selection screen 550, the player can see that in order to continue the game, he must insert a coin before the remaining time displayed in the time display area 552 becomes ‘0’.

Returning to the flow chart of FIG. 24, the play continuation routine executed where the player plays the next game when the current game ends will now be described.

First, a screen by which to confirm the player's play continuation in the next game (not shown in the drawings) is displayed by a continuous participation permission unit 161n, and it is determined whether or not the player will play in the next game (step ST229). If the determination is negative, the sequence advances to step ST239, while if it is positive (‘YES’ in step ST229), player input is received and the number of chips possessed by the player at game end is sought by the game achievement evaluation unit 161l (step ST231).

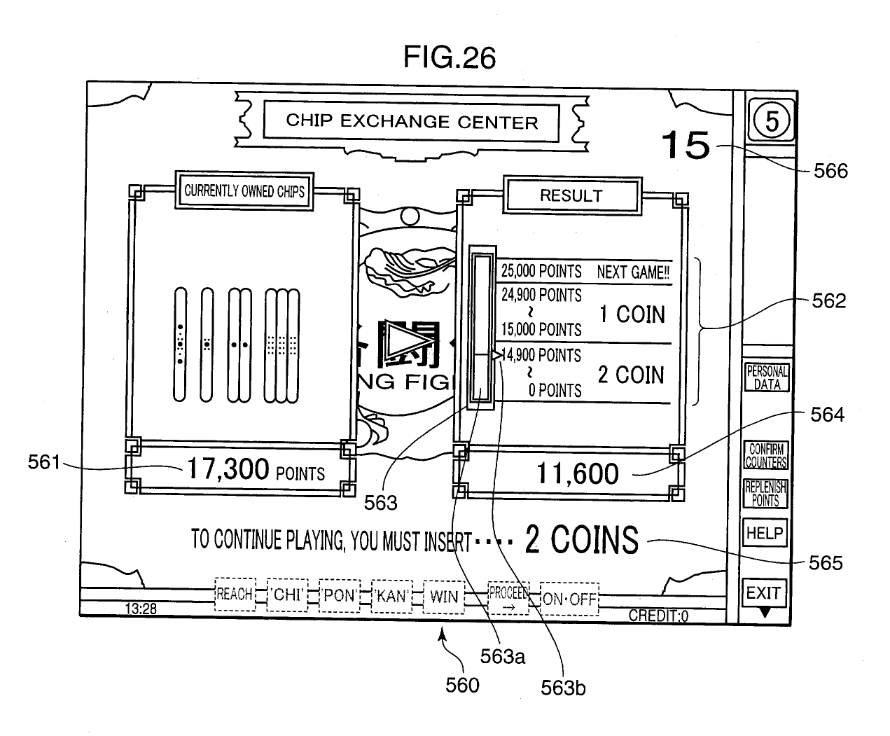

The play continuation condition required to be met by the player to play in the next game is then set by the play continuation condition setting unit 161m based on the sought number of chips possessed (step ST233), and the play continuation condition setting screen shown in FIG. 26 is displayed.

FIG. 26 is an example of a screen drawing of a play continuation condition setting screen. The number of chips 561 possessed by the player at game end is displayed in the left part of the screen. Displayed at the right part of the screen are a message 562 stating ‘25,000 points: Next game!/15,000-24,900 points: 1 coin/0-14,900 points: 2 coins’, and notifying the player of the number of coins or the like required in order to continue playing, a possessed chip gauge 563 that shows the number of chips possessed by the player at game end, and a post-game conversion result 564, displayed at the bottom part of the screen are a play continuation condition display area 565 that displays the message ‘To continue, please insert . . . 2 coins’, notifying the player of the number of coins or the like that must be inserted in order for the player to continue playing the next game, and displayed at the upper right part of the screen is a time display area 566 that displays the time remaining for making the decision by counting down from a prescribed amount of time (here, 30 seconds).

The possessed chip gauge 563 includes a possessed chip bar 563a that fluctuates in length based on the number of chips possessed by the player at game end. An arrow pointer 563b is displayed at the right edge of the possessed chip bar 563a. The arrow pointer 563b moves in accordance with the fluctuation of the possessed chip bar 563a and stops at a position that indicates the number of coins corresponding to the number of chips possessed by the player and displayed in the message 562. The play continuation condition display area 565 displays the number of coins based on the number of points equivalent to possessed chips at which the arrow pointer 563b stopped. The conversion result 564 rises incrementally from a value of ‘0’ to the number of chips possessed by the player at game end in accordance with the fluctuation in the length of the possessed chip bar 563a of the possessed chip gauge 563. Furthermore, while the conversion result 564 is ‘11,600’ in FIG. 26, because this number increases incrementally in accordance with the lengthening of the possessed chip bar 563a and the rising of the arrow pointer 563b, it eventually increases to and stops at 17,300, the value of the number of possessed chips 561.

Returning to the flow chart in FIG. 24, it is determined by the play continuation permission unit 161n whether or not the player's number of possessed chips at game end equals or exceeds a prescribed number of chips SL (here, 25,000) (i.e., whether or not the result is high level) based on the play continuation condition set in step ST233 (step ST235). If this determination is positive (‘YES’ in step ST235), the sequence returns to step ST203, while if it is negative (‘NO’ in step ST235), it is determined whether or not the number of coins set as the play continuation condition corresponding to the player's number of possessed chips at game end has been received by the coin receiving unit 15 (step ST237). If this determination is positive (‘YES’ in step ST237), the sequence advances to step ST237, while if it is negative, game end information indicating that the game has ended is sent to the center server device 3 (step ST239), and the routine ends.

In this embodiment, a determination permitting the player's continuous game participation is made in step ST237 if one coin is received in the coin receiving unit 15 where the player's number of possessed chips is between 15,000 and 24,900, and if two coins are received in the coin receiving unit 15 where the player's number of possessed chips is between 0 and 14,900. In the play continuation condition screen shown in FIG. 26, the time limit for the decision on whether or not the player will continue playing is displayed by the counting down from a prescribed period of time (here, 30 seconds) in the time display area 566. The player indicates his desire to continue playing the game by inserting the number of coins corresponding to his number of possessed chips in the coin receiving unit 15 before the remaining time displayed in the time display area 566 becomes ‘0’, and if no coin is inserted, the player is deemed to have chosen not to continue playing.

Furthermore, in this embodiment, play continuation in the next game is permitted by the client terminal device 1 based on the player's game achievement, but this process can also be performed by the center server device 3.

Because the player's game achievement can be reflected in the next game as described above, a player can be permitted to play in the next game through the use of an relatively easier play continuation condition based on improved game achievement, and the player's enthusiasm for the game can be increased by motivating him to improve his game achievement. Furthermore, because a potentially large number of players can be motivated to play continuously by increasing their enthusiasm for the game, the rate of use of the client terminal devices 1 in this game system can be increased.

Moreover, a player can play in the next game continuously without having to insert another coin, for example, by having a high level game achievement (in this embodiment, by possessing 25,000 or more chips). In other words, because only players who have a certain level of game achievement are permitted to play the next game continuously without the receipt of an additional coin, for example, the player's sense of pride can be satisfied. Furthermore, if players whose game achievement was evaluated to be at a high level, for example, are permitted to play the next game, or are permitted to play indefinitely until they lose, the player becomes motivated to earn the right to play the next game on a continuous basis, and a highly entertaining game can be provided.

In addition, by setting in advance a plurality of incremental play continuation conditions in accordance with the player's game achievement that require a smaller number of coins than the normal number of coins (in this embodiment, three stages in accordance with the number of chips possessed by the player), because even a player who does not have a high level of game achievement can play in the next game on a continuous basis subject to an easier play continuation condition than that required for a regular game, the player can be motivated to try again. Furthermore, because the player's degree of concentration in a game increases because the player wants to obtain the highest possible level of game achievement, a highly entertaining game can be provided.

The present invention can be embodied in the following variations.

(A) In this embodiment, the game executed by the client terminal device 1 was a mah-jongg game, but other multi-player games may be played as well. Such games may include card games, ‘go’, ‘shogi’, shooting games, racing games or the like.

(B) In this embodiment, an arcade server 2 was used, but the client terminal devices 1 may be connected directly to the central server 3 over a network.

(C) In this embodiment, in the flow chart shown in FIG. 24, the determination as to whether or not the player will be permitted to continue playing is made by the life determination unit 161k from the beginning of the game to the end of the game based on the player's life amount, and is made by the game achievement evaluation unit 161l after the game ends based on the player's number of possessed points at game end, but such determination may be made from the beginning of the game to the end of the game as well as after the game ends based on an evaluation by the life evaluation unit 161k based on the player's life amount or based on an evaluation by the game achievement evaluation unit 161l based on the number of chips possessed by the player, which fluctuates upward or downward in accordance with the player's game progress. Moreover, in this embodiment, a mah-jongg game was used as an example, but if the present invention is applied to a different type of game, concepts that correspond to life points and chips may be used in such a game in lieu thereof, depending on the nature of the game.

(D) In this embodiment, as an example, the number of coins required in order to play the next game was set at one or two, the initial number of chips assigned to the player at the beginning of a game was 25,000, the initial life value for the player at the beginning of a game was set at 5000, and the play continuation condition, i.e., the number of coins required for the player to continue playing, was 0 if the player's number of possessed chips was at least 25,000 (no condition), 1 if the player's number of possessed chips was between 15,000 and 24,900, and 2 if the player's number of possessed chips was between 0 and 14,900, but the present invention is not limited to the above play continuation coin requirements, initial chip value, initial life value and play continuation condition, and any desired settings may be used.

Furthermore, if the determination as to whether or not the player will be permitted to continue playing is made based on an evaluation by the life evaluation unit 161k based on the player's amount of life from the beginning of the game to the end of the game and after the game ends, the player's life value at game end may be associated with a number of coins required to play in the next game as a condition for continued game play. For example, a game continuation condition may be adopted in which, where the player's life value at game end is 5000 points or higher, the number of coins required to continue playing is 0, where the player's life value at game end is at least 2000 to 3000 points, the number of coins required to continue playing is 1, and if the player's life value at game end is 0 points, the number of coins required to continue playing is 2.

(E) In this embodiment, an example was used in which a coin was inserted into the coin receiving unit 15 when play continuation was selected, but the present invention is not limited to this implementation. For example, a card or the like may be used instead of a coin.

(F) The construction of the connections between the client terminal devices 1, the arcade server devices 2 and the center server device 3 (i.e., the network) is not limited to the construction shown in FIG. 1. For example, the client terminal devices 1 can be directly connected to the center server device 3 without using arcade server devices 2, and a ring, tree, star or other network configuration may be adopted. In this case, a tree configuration is preferred. Furthermore, by assigning the functions of the center server device 3 to one of the client terminal devices, one client terminal device 1 can be deemed a host terminal device and the other client terminal devices 1 can be connected thereto. Alternatively, a construction may be adopted in which the arcade server devices 2 are assigned the functions of the center server device 3 and are connected to the client terminal devices 1 inside the arcade. It is preferred, however, that the arcade server devices 2 be located between the center server device 3 and the client terminal devices 1 such that processing is distributed among the center server device 3, the arcade server devices 2 and the client terminal devices 1, as shown in FIG. 1. In this case, it is preferred that an arcade server device 2 be located in each arcade and this arcade server device 2 be connected to each client terminal device 1 located in the arcade.

(G) In this embodiment, the player's operations during the game and the player's game achievement at the end of the game were evaluated by the life evaluation unit 161k and the game achievement evaluation unit 161l, respectively, but it is also acceptable if not only the player's operations during the game are evaluated, but also the player's game achievement at game end is evaluated based on the player's life amount, or if the player's operations during the game and the player's game achievement at game end are evaluated by the game achievement evaluation unit 161l based on the player's number of possessed chips.

In summary, one form of the present invention relates to a game server device that is connected to a plurality of terminal devices in a data-communicable fashion and that manages a game played by a plurality of players using said terminal devices. The game server of the present invention comprises: receiving means that receives requests for participation in a game from players at the commencement of a game at each terminal device; selection means that selects from among the players whom game participation requests have been received from, in accordance with prescribed rules, a number of players who are to play in a shared game space, the number being no more than a prescribed maximum number and no less than a prescribed minimum number; and first execution means that allows the selected players to play a game against one another in a shared game space.

According to the above form of the invention, requests for participation in a game are received from players by the receiving means at the commencement of a game at each terminal device, a number of players who are to play in a shared game space are selected by the selection means in accordance with prescribed rules from among the players whose game participation requests have been received, such number being equal to or less than a prescribed maximum and equal to or greater than a prescribed minimum, and a game is executed in a shared game space for the selected players by the first execution means. Therefore, where a rule exists that players having the same level of skill based on past performance are to be chosen as opponents, for example, opponents who are suitable for the player (players having the same skill level) are selected. As a result, a highly skilled player does not feel the dissatisfaction of competing against an inferior opponent, and a game that maintains a certain level of excitement can be ensured.

The game server device may further comprise rank storage means that stores rank information indicating the level of each player's skill in the game in association with the player's identification information, and wherein said selection means selects players based on players' rank information.

According to the present invention with the above feature, rank information that indicates the level of a player's skill in the game is stored in association with the player's identification information, and players are chosen by the selection means based on their rank information. Therefore, where players having differences in rank that fall within a prescribed range are selected, for example, players having roughly the same level of skill are selected to play in a shared game space, and suitable opponents for each player (i.e., opponents having roughly the same skill level as the player) are selected. As a result, the player does not feel the dissatisfaction of competing against an inferior opponent, and a game that maintains a certain level of excitement can be ensured.

The game server device as described above may further comprise title storage means that stores title information that indicates the characteristics of each player in playing the game and in association with the player's identification information, and wherein said selection means selects players based on the players' title information.

According to the invention with the above feature, title information indicating the characteristics of a player's game style are stored in the title storage means in association with the player's identification information, and players are selected by the selection means based on their title information. Accordingly, where the game is a mah-jongg game, and where players who have a game style characteristic that emphasizes the development of a strong hand and are assigned a title corresponding to this characteristic are to be selected, for example, players having the same title are selected to play in a shared game space, which means that opponents suitable for each player (i.e., players having the same game style) are selected. Therefore, a player who emphasizes hand development (development of a winning hand) does not compete against undesirable opponents who score a large number of ‘pon’ and seek to win the deal quickly, thereby ensuring that the game maintains a certain degree of excitement for the player.

The game server device as described above may further comprise standby means that, where a player is not selected by said selection means, places the player on standby status and causes said selection means to perform player selection, and wherein said selection means includes the players placed on standby status by said standby means, among players to be selected from.

According to the invention with the above feature, where a player is not selected by the selection means, the player is placed on standby status by the standby means, and the selection means is commanded to perform player selection at prescribed times in accordance with a method described below. A prescribed number of players are selected by the selection means to play in a shared game space from among players who were placed on standby status by the standby means and players whose game participation requests have been received by the receiving means. Therefore, even where a player is not selected by the selection means, because player selection will be performed once more by the selection means, the likelihood of having suitable opponents selected for each player is increased.

The game server device as described above may further comprise second execution means that allows the players placed on standby status by the standby means to play a game with CPU players in a shared game space.

According to the invention with the above feature, because the second execution means executes a game in a shared game space between players placed on standby status by the standby means and CPU players, even players on standby status can enjoy playing a game.

In the game server device as described above, when a player who has been placed on standby status by said standby means is selected by said selection means, said selection means can be set to notify the terminal device used by the player of such selection.

According to the invention with the above feature, where a player who was placed on standby status by the standby means is selected by the selection means, the terminal device used by that player is notified by the selection means of the player's selection. Accordingly, the player can visually observe his selection by the selection means, and can learn in advance that his situation has changed from playing against CPU players or the like to playing against different players. Consequently, the player can prepare beforehand for a change in his game situation, improving the convenience of the game for the player.

In the game server device as described above, said selection means can be set to perform player selection at least one additional time so long as the number of selected players has not reached said prescribed maximum number.

According to the invention with the above feature, where the number of players selected by the selection means has not reached the prescribed maximum, the selection means performs player selection at least one additional time. Therefore, where the number of players selected by the selection means has not reached the prescribed maximum, because player selection is performed once more, the likelihood of having a larger number of suitable opponents playing in the same game space is increased.

Another form of the present invention relates to a game management method by which a game server device that is connected to a plurality of terminal devices in a data-communicable fashion manages a game that is played by a plurality of players using the plurality of terminal devices, wherein the game server device executes: a receiving process for receiving requests for participation in a game from players at the beginning of a game at the various terminal devices; a selection process for selecting, in accordance with prescribed rules, a number of players who are to play in a shared game space from among the players whom game participation requests have been received from, the number being no more than a prescribed maximum number and no less than a prescribed minimum number; and a first execution process for allowing the selected players to play a game against one another in a shared game space.

According to the above invention, requests for participation in a game are received from players using the various terminals when a game begins in the receiving process, a number of players who are to play in the same game space are selected from among the players whose game participation requests have been received in accordance with prescribed rules in the selection process, such number being equal to or less than a prescribed maximum and equal to or greater than a prescribed minimum, and a game is executed for the selected players in a shared game space in the first execution process. Accordingly, where a rule exists that players having the same level of skill based on past performance are to be chosen as opponents, for example, opponents who are suitable for each player (players having the same skill level) are selected. As a result, a highly skilled player does not feel the dissatisfaction of competing against an inferior opponent, and a game that maintains a certain level of excitement can be ensured.

In the game management program as described above, a game server device that is connected to a plurality of terminal devices in a data-communicable fashion and manages a game played by a plurality of players using the terminal devices to function as: receiving means that receives players' requests for participation in a game at the beginning of a game at the various terminal devices; selection means that selects, in accordance with prescribed rules, from among the players whom game participation requests have been received from, a number of players who are allowed to play in a shared game space, the number being no more than a prescribed maximum number and no less than a prescribed minimum number; and first execution means that allows the selected players to play a game against one another in a shared game space.

According to the invention with the above features, requests for participation in a game are received from players by the receiving means when a game begins at the various terminals, a number of players who are to play in a shared game space are selected by the selection means from among the players whose game participation requests have been received in accordance with prescribed rules, such number being equal to or less than a prescribed maximum and equal to or greater than a prescribed minimum, and a game is executed for the selected players in a shared game space by the first execution means. Accordingly, where a rule exists that players having the same level of skill based on past performance are to be chosen as opponents, for example, opponents who are suitable for the player (players having the same skill level) are selected. As a result, a highly skilled player does not feel the dissatisfaction of competing against an inferior opponent, and a game that maintains a certain level of excitement can be ensured.

In addition, another form of the present invention relates to a game device comprising game execution for executing a competition-type game via operations of a player, and permits the player to join the game subject to a prescribed condition, wherein the game device further comprises: game achievement evaluation means that determines game achievement at the completion of a game by evaluating the operations performed by the player during the game; play continuation condition setting means that sets a play continuation condition for the player for the next game based on the player's game achievement; and continuous participation permission means that, in response to the receipt of a request for continuous participation in the next game, permits the participation in the next game subject to the set play continuation condition.

According to the aforementioned invention, game achievement is sought by the game achievement evaluation means at the completion of a game by evaluating the operations performed by each player during the game, a play continuation condition is set for the player for the next game by the play continuation condition setting means based on the player's game achievement, and participation in the next game is permitted by the continuous participation permission means subject to the set play continuation condition in response to the receipt of a request for continuous participation in the next game.

Because the play continuation condition that must be met by the player in order to play the next game is set at the completion of a game based on the player's game achievement, and participation in the next game is permitted subject to the set play continuation condition, the player's game achievement can be reflected in the next game. Consequently, because the player's game achievement can be reflected in the next game, the play continuation condition for the next game is set based on the player's game achievement. For example, if continuous participation in the next game subject to an relatively easy play continuation condition is allowed when the player's game achievement improves, the player's enthusiasm for the game can be increased due to his desire to improve his game achievement. Furthermore, where continuous participation is permitted through the payment of a smaller number of coins than normal when the player is to participate continuously based on his game achievement, the player can easily play in the next game on a continuous basis, and accordingly the rate of use of the game machine itself can be increased.

In the game device as described in the above, wherein the continuous participation permission means is set to allow a player to begin the next game without regard to said prescribed condition when the next game is begun if said game achievement evaluation indicates that the player's game achievement was at a high level.

According to the invention with the above feature, because each player is allowed to begin the next game without regard to the prescribed condition when the next game is begun if the game achievement evaluation indicates that the player's game achievement was at a high level, a player can play in the next game on a continuous basis without having to add such items as coins by having a high level of game achievement. Furthermore, if a player having a high level of game achievement as determined from the game achievement evaluation can play in the next game on a continuous basis, for example, or can play continuously in successive games until he loses, the possibility of earning the right to play continuously in successive games becomes a form of incentive for the player, so that each player will focus harder on the current game, which in turn promotes the player's continuous participation. Therefore, because a player can play in the next game on a continuous basis without having to add such items as coins by having a high level of game achievement, a form of incentive that will serve to increase the player's focus on the game can be created.

Furthermore, another form of the invention relates to a game management program that causes a game device which comprises game execution means for executing a competition-type game via operation of a player and permits a player to join a game subject to a prescribed condition to function as: game achievement evaluation means that determines game achievement at the completion of a game by evaluating the operations performed by the player during the game; play continuation condition setting means that sets a play continuation condition for the player for the next game based on said game achievement; and continuous participation permission means that, in response to the receipt of a request for continuous participation in the next game, permits participation in the next game subject to the set play continuation condition.

According to the above form of the invention, game achievement is sought by the game achievement evaluation means at the completion of a game via evaluation of player operations during the game, setting of a play continuation condition for the player for the next game is performed by the play continuation condition setting means based on the game achievement, and participation in the next game is permitted by the continuous participation permission means subject to the set play continuation condition in response to the receipt of a request for continuous participation in the next game.

Because a play continuation condition that must be met by a player in order to play the next game is set at the completion of a game based on the game achievement, and participation in the next game is permitted subject to the set play continuation condition, the player's game achievement can be reflected in the next game. Consequently, because the player's game achievement can be reflected in the next game, the play continuation condition for the next game is set based on the player's game achievement. For example, if continuous participation in the next game subject to a relatively easy play continuation condition is allowed when the player's game achievement improves, the player's enthusiasm for the game can be increased due to his desire to improve his game achievement. Furthermore, where continuous participation is permitted through the payment of a smaller number of coins than normal when the player is to participate continuously based on the game achievement, the player can easily play in the next game on a continuous basis, and accordingly the rate of use of the game machine itself can be increased.

Yet furthermore, still another form of the present invention relates to game management method that is executed using a game device that comprises game execution means for executing a competition-type game via operation of a player and permits the player to join a game subject to a prescribed condition, wherein the game device executes: a game achievement evaluation process in which game achievement is determined at the completion of a game by evaluating the player operations during the game; a continuous condition setting process in which a play continuation condition that must be met by the player in order to play the next game is set based on the player's game achievement; and a continuous participation permission process in which participation in the next game is permitted in response to the receipt of a request for continuous participation in the next game.

According to the above form of the invention, game achievement is sought in the game achievement evaluation process at the completion of a game via evaluation of player operations during the game, setting of a play continuation condition for the player for the next game is performed in the play continuation condition setting process based on the game achievement, and participation in the next game subject to the set play continuation condition is permitted in the continuous participation permission process in response to the receipt of a request for continuous participation in the next game.

Because the play continuation condition that must be met by a player in order to play the next game is set based on the player's game achievement at the completion of a game, and participation in the next game is permitted subject to the set play continuation condition, the player's game achievement can be reflected in the next game. Consequently, because the player's game achievement can be reflected in the next game, the play continuation condition for the next game is set based on the player's game achievement. For example, if continuous participation in the next game subject to a relatively easy play continuation condition is allowed when the player's game achievement improves, the player's enthusiasm for the game can be increased due to his desire to improve his game achievement. Furthermore, where continuous participation is permitted through the payment of a smaller number of coins than normal when the player is to participate continuously based on his game achievement, the player can easily play in the next game on a continuous basis, and accordingly the rate of use of the game machine itself can be increased.

This application is based on Japanese patent applications serial no. 2001-367596 and 2001-401845, filed in Japan Patent Office on Nov. 30, 2001 and Dec. 28, 2001, respectively, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. A game server device that is connected to a plurality of terminal devices in a data-communicable fashion and that manages a game played by a plurality of players using said terminal devices, said game server device comprising:
receiving means that receives requests for participation in a game from players at commencement of a game at each terminal device;
selection means that selects from among the players whom game participation requests have been received from, in accordance with prescribed rules, a number of players who are to play in a shared game space, the number being no more than a prescribed maximum number and no less than a prescribed minimum number; and
first execution means that allows the selected players to play a game against one another in a shared game space.

2. The game server device according to claim 1, further comprising rank storage means that stores rank information indicating the level of each player's skill in the game in association with the player's identification information, and wherein said selection means selects players based on players' rank information.

3. The game server device according to claim 1, further comprising title storage means that stores title information that indicates the characteristics of each player in playing the game and in association with the player's identification information, and wherein said selection means selects players based on the players' title information.

4. The game server device according to claim 1, further comprising standby means that, where a player is not selected by said selection means, places the player on standby status and causes said selection means to perform player selection, and wherein said selection means includes the players placed on standby status by said standby means, among players to be selected from.

5. The game server device according to claim 4, further comprising second execution means that allows the players placed on standby status by the standby means to play a game with CPU players in a shared game space.

6. The game server device according to claim 4, wherein when a player who has been placed on standby status by said standby means is selected by said selection means, said selection means notifies the terminal device used by the player of such selection.

7. The game server device according to claim 1, wherein so long as the number of selected players has not reached said prescribed maximum number, said selection means performs player selection at least one additional time.

8. A game management method by which a game server device that is connected to a plurality of terminal devices in a data-communicable fashion manages a game that is played by a plurality of players using the plurality of terminal devices, wherein the game server device executes the following steps:
a receiving process for receiving requests for participation in a game from players at beginning of a game at the various terminal devices;
a selection process for selecting, in accordance with prescribed rules, a number of players who are to play in a shared game space from among the players whom game participation requests have been received from, the number being no more than a prescribed maximum number and no less than a prescribed minimum number; and
a first execution process for allowing the selected players to play a game against one another in a shared game space.

9. A recording medium which stores a game management program that causes a game server device, that is connected to a plurality of terminal devices in a data-communicable fashion and manages a game played by a plurality of players using the terminal devices, to function as:
receiving means that receives players' requests for participation in a game at the beginning of a game at the various terminal devices;
selection means that selects, in accordance with prescribed rules, from among the players whom game participation requests have been received from, a number of players who are allowed to play in a shared game space, the number being no more than a prescribed maximum number and no less than a prescribed minimum number; and
first execution means that allows the selected players to play a game against one another in a shared game space.

10. A game device which permits the player to join the game subject to a prescribed condition, comprising:
game execution means for executing a competition-type game via operations of a player;
game achievement evaluation means that determines game achievement at the completion of a game by evaluating the operations performed by the player during the game;
play continuation condition setting means that sets a play continuation condition for the player for the next game based on the player's game achievement; and
continuous participation permission means that, in response to the receipt of a request for continuous participation in the next game, permits the participation in the next game subject to the set play continuation condition.

11. The game device according to claim 10, wherein the continuous participation permission means allows a player to begin the next game without regard to said prescribed condition when the next game is begun if said game achievement evaluation indicates that the player's game achievement was at a high level.

12. A recording medium which stores a game management program that causes a game device which comprises game execution means for executing a competition-type game via operation of a player and permits a player to join a game subject to a prescribed condition to function as:
game achievement evaluation means that determines game achievement at the completion of a game by evaluating the operations performed by the player during the game;
play continuation condition setting means that sets a play continuation condition for the player for the next game based on said game achievement; and
continuous participation permission means that, in response to the receipt of a request for continuous participation in the next game, permits participation in the next game subject to the set play continuation condition.

13. A game management method that is executed using a game device that comprises game execution means for executing a competition-type game via operation of a player and permits the player to join a game subject to a prescribed condition, wherein the game device executes the following steps:
a game achievement evaluation process in which game achievement is determined at the completion of a game by evaluating the player operations during the game;
a continuous condition setting process in which a play continuation condition that must be met by the player in order to play the next game is set based on the player's game achievement; and
a continuous participation permission process in which participation in the next game is permitted in response to the receipt of a request for continuous participation in the next game.
